(19) United States
(12) Patent Application Publication
(10) Pub. No.: US 2006/0082472 A1
(43) Pub. Date: Apr. 20, 2006

(54) Traffic information providing system,traffic information expression method and device

(76) Inventors: Shinya Adachi, Kanagawa (JP); Rie Ikeda, Tokyo (JP)

Correspondence Address: PEARNE & GORDON LLP, 1801 EAST 9TH SRTEET, SUITE 1200, CLEVELAND, OH, 44114-3108, US

(21) Appl. No.: 10/541,042

(22) PCT Filed: Dec. 26, 2003
(86) PCT No.: PCT/JP03/17052

§ 371 Date: Jun. 24, 2005

(30) Foreign Application Priority Data
Dec. 27, 2002 (JP) 2002380403
Dec. 27, 2002 (JP) 2002380404
Dec. 12, 2003 (JP) 2003414296

(51) Int. Cl. G08G 1/123; G08G 1/09; G08G 1/01; G08G 1/00

(52) U.S. Cl. 340/995.13; 340/905; 340/933; 701/117

(57) ABSTRACT

The invention provides a traffic information display method which presents traffic information so as to quantatively indicate the reliability and superiority of traffic information. The invention also provides a traffic information providing system which clearly communicates an “unknown” section to the receiving party. The invention represents the state volume of traffic information by the state volume of each sampling point set by segmenting a target road and represents traffic information by using the state volume of traffic information and gray scale information which displays the reliability of the state volume in multiple levels. The user thus understands how reliable the traffic information is and properly evaluates the traffic information. The traffic information may be used to perform a high-accuracy path search and provide traffic information at a reasonable cost. The traffic information providing system of the invention includes traffic information providing apparatus for providing, as traffic information, the state volume of traffic information of each distance quantization unit set by segmenting a target road and mask bit information indicating that the state volume is valid or invalid, and traffic information utilization apparatus for reproducing a valid state volume by using the mask bit information. In the traffic information providing system, the receiving party clearly recognizes, based on the mask bit information, an “unknown” section enclosed by an ellipse:

### TECHNICAL FIELD

The present invention relates to a system for providing traffic information such as congestion and travel time, a method of representing the traffic information, and apparatus constituting the system, and in particular to such a system, a method and apparatus capable of correctly transmitting the information contents in providing data of traffic information.

Further, the invention relates to a method of representing various information associated with roads, such as road traffic information and path information, a system for generating, displaying and utilizing the information, and apparatus constituting the system, and in particular to such a system, a method and apparatus capable of displaying the reliability and superiority of information.

### BACKGROUND TECHNOLOGY

VICS (Vehicle Information and Communication System) which currently provides a car navigation system with a traffic information providing system collects and edits traffic information and transmits traffic congestion information and travel time information representing the time required by way of an FM multiplex broadcast or a beacon.

The current VICS information represents the current traffic information as follows:

Traffic situation is displayed in three levels, congestion (ordinary road: ≦10 km/h; expressway: ≦20 km/h);

heavy traffic (ordinary road: 10-20 km/h; expressway: 20-40 km/h); and light traffic (ordinary road: ≧20 km/h; expressway: ≧40 km/h).

The traffic congestion information representing the traffic congestion is displayed as

“VICS link number+state (congestion/heavy traffic/light traffic/unknown)” in case the entire VICS link (position information identifier used by VICS) is congested uniformly.

In case only part of the link is congested, the traffic congestion information representing the traffic congestion is displayed as

“VICS link number+congestion head distance (distance from beginning of link)+congestion end (distance from beginning of link)+state (congestion)”

In this case, when the congestion starts from the start end of a link, the head congestion distance is displayed as 0×ff. In case different traffic situations coexist in a link, each traffic situation is respectively described in accordance with this method.

The link travel time information representing the travel time of each link is displayed as

“VICS link number+travel time”

As prediction information representing the future change trend of traffic situation, an increase/decrease trend graph showing the four states, “increase trend/decrease trend/no change/unknown” is displayed while attached to the current information.

VICS traffic information displays traffic information while identifying a road with a link number. The receiving party of this traffic information grasps the traffic situation of the corresponding road on its map based on the link number. The system where the sending party and receiving party shares link numbers and node numbers to identify a position on the map requires introduction or a change in new link numbers and node numbers each time a road is constructed anew or changed. With this, the data on the digital map from each company needs updating so that the maintenance requires huge social costs.

In order to offset these disadvantages and transmitting a road position independently of a VICS number, the inventor of the invention proposes, in Japanese Patent Laid-Open. No. 2001-41757 and Japanese Patent Laid-Open No. 2001-66146, a system where a sending party arbitrarily sets a plurality of nodes on a road shape and transmits a “shape vector data string” representing the node position by a data string and a receiving party uses the shape vector data string to perform map matching in order to identify a road on a digital map.

The inventor also proposes a method of presenting traffic information based on the philosophy which represents the state volume of traffic information changing along a road.

This method generates traffic information as follows:

As shown in FIG. 23A, a shape vector (road) having a distance of X m is equidistantly segmented from a reference node by a unit block length (Example: 50-500 m) to perform sampling. As shown in FIG. 23B, the average speed of a vehicle passing through each sampling point is obtained. In FIG. 23B, the value of the obtained speed is shown in a square representing the quantization unit set through sampling. In this case, the average travel time or congestion rank of a vehicle passing through each sampling interval may be obtained instead of the average speed.

Next, the data string of the speed value is encoded/compressed in order to reduce the volume of data used to transmit the traffic information. The compression coding may use approaches such as the variable length coding (Huffman/arithmetic code/Shannon-Fano, etc.) and discrete wavelet transform (DWT).

The encoded traffic information is transmitted together with the shape vector data string information (FIG. 24A) representing the road shape of the target road, as shown in FIGS. 24A and 24B. The traffic information data (FIG. 24B) includes, on top of encoded data of traffic information, information used to identify the target road section in association with the shape vector data string information, as well as information on number of quantization units, length of unit block, and encoding system.

A receiving party which has received the above information decodes the encoded shape vector data and performs map matching on its own digital map data in order to identify the target road section on its own map and decode the encoded traffic information to represent the traffic information on the target road section.

The Japanese Patent Application 2002-89069 develops the above philosophy and proposes a method of presenting traffic information which represents the state volume of traffic information changing along a road.

This method generates traffic information as follows:

As shown in FIG. 34A, a shape vector (road) having a distance of X m is equidistantly segmented from a reference node by a unit block length (Example: 50-500 m) to perform sampling. As shown in FIG. 34B, the average speed of a vehicle passing through each sampling point is obtained. In FIG. 34B, the value of the obtained speed is shown in a square representing the quantization unit set through sampling. In this case, the average travel time or congestion rank of a vehicle passing through each sampling interval may be obtained instead of the average speed.

Next, the speed value is converted to a quantized volume by using the traffic information quantization table shown in FIG. 35. In the traffic information quantization table, in response to the user's request for detailed information of congestion, setting is made so that the quantized volume will increase in steps of 1 km/h in case the speed is less than 10 km/h, 2 km/h in case the speed is within the range of 10 to 19 km/h, 5 km/h in case the speed is within the range of 20 to 49 km/h, and 10 km/h in case the speed is equal to or more than 50 km/h. Quantized values obtained using the traffic information quantization table are shown in FIG. 34C.

Next, the quantized volume is represented by a difference from the statistical prediction value. In this example, difference between the quantized speed Vn in the target quantization unit and a quantized speed Vn−1 in the upstream quantization unit or statistical prediction value S is calculated by using (Vn−Vn−1). The calculation result is shown in FIG. 34D.

In case the quantized value is represented by a difference from the statistical prediction value, frequency of appearance of values around ±0 becomes higher because traffic situation is similar between adjacent quantization units.

Variable length encoding is performed on the data thus processed. That is, past traffic information is analyzed and an encoding table for encoding the statistical prediction difference value of traffic information is created, as shown in FIG. 36. By using the encoding table, the value in FIG. 34D is encoded. For example, +2 is encoded to “1111000” while −2 is encoded to “1111001”. In case 0 continues, such as 00000, the data is encoded to “100”.

In this way, by quantizing the traffic information and converting the quantized value to a statistical prediction value and increasing the frequency of values appearing around ±0, the effect of data compression through variable length encoding (Huffman/arithmetic code/Shannon-Fano, etc.) or run-length compression (run-length encoding) is enhanced. In particular, in case the congestion information is displayed in ranks of four levels as in the related art, the statistical prediction difference value in most quantization units is 0 so that the effect of run-length compression is very high.

The traffic information thus encoded is, as shown in FIGS. 37A and 37B, formed into the data having the data structure of FIG. 37B, together with the shape vector data string information representing a road shape, and is then transmitted. On top of the information, a shape vector encoding table, a traffic information quantization table (FIG. 35), and an encoding table of statistical prediction difference values of traffic information (FIG. 36) are transmitted in the same occasion or over a separate route.

The receiving party which has received the above information decodes the shape vector in each traffic-information-provided section and performs map matching on its own digital map data in order to identify the target road section on its own map and decode the traffic information on this target road section while referencing the encoding table.

By doing so, the receiving party can reproduce the traffic information changing along a road (traffic information represented in a function of distance from a reference node).

The state volume f traffic information changing along a road (FIG. 34B) can be converted to several waveforms having separate frequency components for the receiving party to reproduce the state volume of traffic information even in case the coefficient value of each frequency is provided.

The conversion to frequency components uses approaches such as FFT (Fast Fourier Transform), DCT (Discrete Cosine Transform), and DWT (Discrete Wavelet Transform). For example, the Fourier Transform technique can obtain a Fourier coefficient C(k) from a finite number of discrete values (state volume) represented in a complex function f by way of Expression 1 (Fourier Transform).
C(k)=(1/n)Σf(j)·ω−jk (k=0,1,2, . . . ,n-1) (Expression 1)
(Σ means sum from j=0 to n-1)

When C(k) is given, a discrete value (state volume) is obtained by way of Expression 2(Inverse Fourier Transform).
F(j)=ΣC(k)·ωjk (j=0,1,2, . . . ,n-1) (Expression 2)
(Σ means sum from k=0 to n-1)

A party which provides traffic information converts the state volume of traffic information to n (=2N) coefficients and quantizes the coefficient. The value obtained through the quantization is obtained as follows: a coefficient of a low frequency is divided by 1; as a coefficient pertains to a higher frequency, a larger value than 1 is used to divide the coefficient by, and the fraction is rounded off. The quantized value is compressed through variable length compression and is then transmitted. In this case, the data structure of traffic information is as shown in FIG. 38.

The receiving party which has received the traffic information decodes and dequantizes the coefficient and reproduces the state volume of traffic information by using Expression 2.

In this way, in case traffic information is converted to a coefficient of a frequency component before it is transmitted, adjusting the value to be divided in quantization obtains a wide range of data from “transmit data with a large volume of information which provides correct reproduction accuracy of traffic information” to “transmit data with a small volume of information which provides lower reproduction accuracy of traffic data”. In case coefficient information is transmitted layer by layer in ascending order of frequency, the receiving party obtains an outline of the image when it has obtained the information of the coefficient of a lower frequency before obtaining the entire data even when the transmission speed is low. In an early level, the receiving party can determine whether the traffic information is “required or not” and in case not require, skip the information.

Traffic changes with time. As time elapses from the point in time traffic is measured, reliability of traffic information drops. On a road where sensors to measure traffic situation (ultrasonic vehicle sensors, loop coil sensors, image sensors, etc.) are densely installed, traffic can be measured with high accuracy. On the other hand, on a road where such sensors are sparsely installed, measurement accuracy of traffic is lowered, with lower reliability of traffic information.

In this way, reliability of traffic information is not uniform but depends on time and location. There has never been a service which provides traffic information together with its reliability.

The user thus has difficulty in correctly evaluating the presented traffic information. The user, encountering a scene where the provided traffic information is different from the actual situation, may feel an unwanted sense of distrust to the overall traffic information.

The user empirically understands the natural congestion of a road where the/she uses for commuting and expects “the speed of the flow of cars and how long will it take to get out of congestion” but cannot make a guess when the/she has encountered an abrupt congestion due to an accident or construction. Thus, the information indicating “whether the current traffic is more congested than usual in terms of the user's daily experience” or information indicating “whether the congestion will be worse or better” is quite useful when the user selects his/her route.

VICS provides “event information” in order to notice an abrupt event. This represents “an accident,” “a construction,” “a control (such as lane control and road closing),” “road abnormalities (road blocking due to cave-in, submersion in water, or collapse of peripheral facilities such as trees and buildings),” and “weather (in particular snowfall and icy road.” A driver who has acquired such information can select another road.

It is difficult to gather the event information by way of a sensor. In general, an operator in a center manually enters or deletes information based on the information transmitted over the telephone, etc. to the center. Checkup of the credulity of the information and management of information via human intervention is cumbersome so that only a small part of information which has a large influence is input or provided.

A large number of related art car navigation units mount a feature to perform path search while considering the added congestion information. A service is provided where, in response to information on a start point and a destination transmitted to the center, information on the recommended path from the center which has searched for routes and the destination is received. Such path search approaches use a link cost modified based on congestion information to calculate a recommended path. Unknown reliability of the congestion information will make an adverse effect on the result of path search.

A shortest-time route calculated based on the link cost alone is not necessarily a desirable one to the driver. A driver will generally wish to choose a familiar, frequented route provided the route has a small time difference from the shortest-time route. On the other hand, in case the time difference is large, the driver will wish to use the shortest-time route. In order for the driver to select a route based on such psychological background, additional information which compares the retrieved route and the familiar route is required. The related art path search techniques do not provide such additional information.

It is expected that a service to offer traffic information on a chargeable basis will be available. Traffic information with lower reliability which costs the user the same charge as traffic information with higher reliability will alienate the user.

In the related art method of representing traffic information, it is difficult to appropriately represent, without degrading the accuracy of information, an “unknown” section caused by a faulty vehicle sensor or absence of information.

Representation of “an unknown section” may include a method of defining a value as “invalid traffic information.” When irreversible compression is made to traffic information, the value of an “unknown” section changes from the value of “invalid traffic information.” An example of this is representing a quantized traffic state volume in a difference from the statistical prediction value. In this case, when the value Vn−1 of the upstream quantization unit is subtracted from the quantization unit value Vn in question to obtain a statistical prediction value S being (Vn−Vn−1), the value of the “unknown” section changes from the value of “invalid traffic information.”

In case the state volume of traffic information is represented in a coefficient of a frequency component, conversion/inverse conversion of the frequency component smoothes values in the “unknown” section and values in the sections preceding and following the section or approximates those values. This may cause a value to drift from a value of “invalid traffic information” or cause a value in the section preceding or following the section to change with the value in the “unknown” section. When a large value which could not exist is used to represent “invalid”, the dynamic range is enhanced so that the overall error is extended.

### DISCLOSURE OF THE INVENTION

The invention solves the foregoing related art problems and has an object to provide a representation method of representing traffic information and path information together with its reliability and superiority and apparatus and a system which generate, display and utilize the traffic information and path information having such attribute information.

The invention has another object to provide a traffic information providing system capable of communicating an “unknown” section to a receiving party and a method of representing traffic information, and apparatus constituting the system.

To this end, the invention represents road-related information such as traffic information and path information together with gray scale information which displays the attributes of the information in multiple levels.

The gray scale information is a representation, in more than one level, of some characteristics of the provided road-related information such as traffic information and path information and some auxiliary information to help the user of the information determine the information more precisely.

The user can utilize the gray scale information to understand the reliability of the provided road-related information and superiority of the provided path information.

The invention displays the reliability of the state volume of traffic information in multiple levels by way of the gray scale information.

The user thus understands how reliable the traffic information is and is able to correctly evaluate the traffic information.

The invention displays the difference of the state volume of traffic information from that in ordinary traffic by way of the gray scale information.

The user thus understands that the current traffic is as usual or that an abrupt, unpredictable state is there.

The invention displays the change in the state volume of the traffic information in multiple levels by way of the gray scale information.

The user thus understands whether the congestion is becoming worse or better.

The invention displays the superiority of a shortest-travel-time path over a reference path in multiple levels.

The user can make selection: in case a shortest-travel-time path is provided, the user selects the shortest-travel-time path in a higher-superiority section and a familiar, frequented path in a lower-superiority section.

The invention provides the terminal apparatus with reception means for receiving gray scale information which displays the state volume of traffic information and the attribute of the shortest-time route in multiple levels and display means for displaying the state volume of traffic information in a form corresponding to the value of gray scale information.

The user thus recognizes the reliability of traffic information and an unpredictable traffic state from the display on the terminal apparatus.

The invention provides the terminal apparatus with transmission means for transmitting the information on the current location and the destination, reception means for receiving the path information and the gray scale information to displays the superiority of the path information in multiple levels, and display means for displaying the path information in a form corresponding to the value of gray scale information.

On the terminal apparatus, information on the current location and the destination is transmitted and path information is provided. The user can determine whether to follow the provided path information based on the superiority of the path information.

The invention provides the terminal apparatus with reception means for receiving traffic information, route calculation means for calculating a shortest-travel-time path from the current location to the destination while referencing the traffic information, attribute information calculation means for generating the gray scale information to display the superiority of the shortest-travel-time path in multiple levels, and display means for displaying the shortest-travel-time path in a form corresponding to the value of gray scale information.

The terminal apparatus can receive traffic information and generate the path information to the destination and corresponding gray scale information.

The invention provides the path information calculation apparatus with dynamic link cost calculation means for calculating the dynamic link cost for a link based on the state volume of traffic information, static link cost calculation means for calculating the static link cost for the link, static link cost provision means for providing the static link cost for the link, and link cost determination means for changing the distribution ratio of the dynamic link cost and static link cost based on the gray scale information which represents the reliability of the superiority of traffic information in multiple levels in order to generate a link cost used for path calculation.

The path information calculation apparatus can properly set a link cost so that it is possible to perform path search at high accuracy.

The traffic information providing system of the invention comprises traffic information providing apparatus for retaining, as traffic information, the state volume of traffic information and gray scale information which displays the reliability of the state volume in multiple levels and providing traffic information to which the gray scale information is appended, and client apparatus for receiving the traffic information from the traffic information providing apparatus, in order for the traffic information providing apparatus to set the value of traffic information to be provided to the client apparatus in accordance with the gray scale information appended to the traffic information.

This system provides a reasonable charging system in which, traffic information with a higher accuracy costs the user a higher change. While traffic information with a lower accuracy costs the user a lower change.

The traffic information providing system of the invention comprises traffic information providing apparatus for providing, as traffic information, the state volume of traffic information at each of the sampling points set by segmenting a target road and mask bit information indicating that the state volume is valid or invalid, and traffic information utilization apparatus for receiving the traffic information and reproducing the valid state volume by using the mask bit information.

The receiving party thus correctly identifies the “unknown” section based on the mask bit information.

The traffic information providing apparatus of the invention comprises a traffic information converter for converting the state volume of traffic information changing along a road to an array of the values of sampling points set by segmenting the target road and generating an array of mask bits representing the validity or invalidity of the values of the sampling points, an encoder for encoding the data generated by the traffic information converter from the state volume of the traffic information and the data of mask bit information, and an information transmitter for transmitting the data encoded by the encoder.

The traffic information utilization apparatus comprises an information receiver for receiving, from the traffic information providing apparatus, the encoded data concerning the state volume of the traffic information of the target road, the encoded data of mask information representing the validity or invalidity of the state volume, and road section reference data to identify the target road, a decoder for decoding each item of said encoded data and reproducing the valid state volume from the state volume of the traffic information and the mask bit information, and a determination section for performing map matching by using the road section reference data to identify the target road of traffic information.

The traffic information providing apparatus and the traffic information utilization apparatus may be used to constitute the traffic information providing system of the invention.

The traffic information display method of the invention sets sampling points by segmenting the target road of traffic information, sets 1s of mask bit information in correspondence with the sampling points where valid state volumes of traffic information are obtained and sets 0s of mask bit information in correspondence with the sampling points where valid state volumes of traffic information are not obtained, and presents an array of mask bit information together with an array of state volumes of these sampling points.

Thus, the receiving party which has received the traffic information correctly identifies an “unknown” section base on the mask bit information.

### BRIEF DESCRIPTION OF THE DRAWINGS

FIG. 1A shows data used to implement a traffic information representation method according to a first embodiment of the invention;

FIG. 1B shows data used to implement a traffic information representation method according to the first embodiment of the invention;

FIG. 2A is a printout of a figure showing the color-display traffic information representation method according to the first embodiment of the invention, where the reliability of a state volume is presented in the degree of watermark of a color line;

FIG. 2B is a printout of a figure showing the color-display traffic information representation method according to the first embodiment of the invention, where the reliability of a state volume is presented in the thickness of a color line;

FIG. 2C is a printout of a figure showing the color-display traffic information representation method according to the first embodiment of the invention, where the reliability of a state volume is presented in solid/dashed color lines;

FIG. 3 shows a loop coil sensor;

FIG. 4 shows an ultrasonic sensor;

FIG. 5 shows an image sensor;

FIG. 6 is a block diagram showing a configuration of a gray scale information generating section according to the first embodiment of the invention;

FIG. 7 is block diagram showing a configuration of a path information calculator according to a second embodiment of the invention;

FIG. 8 is block diagram showing a configuration of a traffic information providing system according to a third embodiment of the invention;

FIG. 9 shows a change in the travel time during an abrupt congestion;

FIG. 10 is a block diagram showing the system configuration according to a fourth embodiment of the invention;

FIG. 11 is a flowchart showing a processing procedure in the system according to the fourth embodiment of the invention;

FIG. 12 illustrates alienation of a measured value from an average of statistical value;

FIG. 13A shows a data structure of traffic information transmitted by the system according to the fourth embodiment of the invention, where position reference information is shown;

FIG. 13B shows a data structure of traffic information transmitted by the system according to the fourth embodiment of the invention, where encoded traffic information is shown;

FIG. 14 is a block diagram showing a configuration of a system according to a fifth embodiment of the invention;

FIG. 15 is a flowchart showing a processing procedure in the system according to the fifth embodiment of the invention;

FIG. 16 is a block diagram showing a configuration of a system (CDRGS) according to a seventh embodiment of the invention;

FIG. 17 is a flowchart showing a processing procedure in the system (CDRGS) according to the seventh embodiment of the invention;

FIG. 18A shows a data structure of traffic information transmitted by the system according to the seventh embodiment of the invention, where position reference information of a route is shown;

FIG. 18B shows a data structure of path information transmitted by the system according to the seventh embodiment of the invention, where attribute information is shown;

FIG. 19 is a printout of a figure (color) showing the display form of a provided route in the seventh embodiment of the invention;

FIG. 20 is a flowchart showing another processing procedure in the system (CDRGS) according to the seventh embodiment of the invention;

FIG. 21 is a block diagram showing a configuration of a system (LDRGS) according to the seventh embodiment of the invention;

FIG. 22 is a flowchart showing a processing procedure in the system (LDRGS) according to the seventh embodiment of the invention;

FIG. 23A illustrates related art traffic information;

FIG. 23B illustrates related art traffic information;

FIG. 24A shows a data structure of related art traffic information, where shape vector data string information is shown;

FIG. 24B shows a data structure of related art traffic information, where traffic information is shown;

FIG. 25A shows a method of representing traffic information according to an eighth embodiment of the invention, where encoded/compressed information is schematically shown;

FIG. 25B shows a method of representing traffic information according to the eighth embodiment of the invention, where decoded information is schematically shown;

FIG. 25C shows a method of representing traffic information according to the eighth embodiment of the invention, where traffic information reproduced using the decoded-information is schematically shown;

FIG. 26 is block diagram showing a configuration of a traffic information providing system according to the eighth embodiment of the invention;

FIG. 27 is a flowchart showing an operation of the traffic information providing system according to the eighth embodiment of the invention;

FIG. 28 is a flowchart showing another operation of the traffic information providing system according to the eighth embodiment of the invention;

FIG. 29 shows a data structure of traffic information according to the he eighth embodiment of the invention;

FIG. 30A illustrates data setting in a section where traffic information is unknown according to the eighth embodiment of the invention;

FIG. 30B illustrates data setting in the section where traffic information is unknown according to the eighth embodiment of the invention;

FIG. 30C illustrates data setting in the section where traffic information is unknown according to the eighth embodiment of the invention;

FIG. 30D illustrates data setting in the section where traffic information is unknown according to the eighth embodiment of the invention;

FIG. 31A illustrates road section reference data according to the eighth embodiment of the invention;

FIG. 31B illustrates road section reference data according to the eighth embodiment of the invention;

FIG. 31C illustrates road section reference data according to the eighth embodiment of the invention;

FIG. 32 is a block showing a traffic information providing system according to a ninth embodiment of the invention;

FIG. 33 shows a data structure of transmit data (an example of format of transmit data from a probe car to a center) in the traffic information providing system according to the ninth embodiment of the invention;

FIG. 34A illustrates related art traffic information;

FIG. 34B illustrates related art traffic information;

FIG. 34C illustrates related art traffic information;

FIG. 34D illustrates related art traffic information;

FIG. 35 shows a speed quantization table used to quantize related art traffic information;

FIG. 36 shows an encoding table (an example of an encoding table of statistical prediction values of traffic information) used in encoding of related art traffic information;

FIG. 37A shows a data structure of related art traffic information, where shape vector data string information (encoded/compressed data) is shown;

FIG. 37B shows a data structure of related art traffic information, where traffic information is shown; and

FIG. 38 shows another data structure (an example of FFT-represented traffic information) of related art traffic information.

Reference numerals throughout the figures represent: 10: Traffic information measurement apparatus; 11: Sensor processor A; 12: Sensor processor B; 13: Sensor processor C; 14: Traffic information calculator; 15: Traffic information transmitter; 21: Sensor A (ultrasonic vehicle sensor); 22: Sensor B (image sensor); 23: Sensor C (probe car); 30: Traffic information/attribute information generator/transmitter; 31: Current traffic information collector; 32: Statistical information accumulating section; 33: Traffic information converter; 34: Encoder; 35: Information transmitter; 36: Digital map database A; 37: Attribute information generator; 38: Attribute information calculator; 40: Route calculator; 60: Receiving party apparatus; 61: Information receiver; 62: Decoder; 63: Position reference section; 64: Traffic information/attribute information processor; 65: Digital map database B; 66: Link cost table; 67: Information utilization section; 68: Local vehicle position determination section; 69: GPS antenna; 70: Gyroscope; 71: Guidance apparatus; 72: Travel locus accumulating section; 73: Information transmitter; 74: Reference information determination section; 75: Reference information input MMI; 76: Wiper; 77: Current position/destination setting section; 78: Destination input MMI; 79: Route information/attribute information utilization section; 80: Gray scale information generator; 81: Traffic information accumulating section; 82: Gray scale information calculator; 83: Definition table; 84: Statistical traffic information generator; 85: Prediction information generator; 86: Traffic information editing section; 87: Bypath information generator; 88: Probe car measurement information generator; 89: Statistical traffic information database; 90: Sensor A traffic determination section; 91: Sensor Z traffic determination section; 92: Probe car traffic determination section; 93: Bypath information database; 100: Path information calculator; 101: Traffic information receiver; 102: Dynamic link cost calculator; 103: Path calculation condition determination section; 104: Link cost determination section; 105: Map database; 106: Path calculation link cost accumulating section; 107: Path calculator; 108: Path calculation result transmitter; 120: Traffic information transmitter/information charge calculator; 121: Traffic information database; 122: Traffic information transmission area/target road determination section; 123: Request information receiver; 124: Information charge determination section; 125: Traffic information editing section; 126: Traffic information transmitter; 127: Charge database; 130: Client apparatus; 131: Request information transmitter; 132: Information request area/target road determination section; 133: Input operation section; 134: Traffic information receiver; 135: Decoder; 136: Traffic information utilization section; 137: Digital map database; 180: MMI section; 181: Traffic information receiver; 182: Route calculator; 183: Attribute information calculator; 300: Route/attribute information calculator/transmitter; 1010: Traffic information measurement apparatus; 1011: Sensor processor A; 1012: Sensor processor B; 1013: Sensor processor C; 1014: Traffic information calculator; 1021: Sensor A (ultrasonic vehicle sensor); 1022: Sensor B (AVI sensor); 1023: Sensor C (probe car); 1030: Traffic information transmitter; 1031: Traffic information collector; 1032: Quantization unit determination section; 1033: Traffic information converter; 1034: Encoder; 1035: Information transmitter; 1036: Digital map database; 1050: Encoding table creating section; 1051: Encoding table calculator; 1052: Encoding table; 1053: Traffic information quantization table; 1054: Distance quantization unit parameter table; 1060: Receiving party apparatus; 1061: Information receiver; 1062: Decoder; 1063: Map matching and section determination section; 1064: Traffic information reflecting section; 1066: Link cost table; 1067: Information utilization section; 1068: Local vehicle position determination section; 1069: GPS antenna; 1070: Gyroscope; 1071: Guidance apparatus; 1080: Probe car collection system; 1081: Travel locus measurement information utilization section; 1082: Encoded data decoder; 1083: Travel locus receiver; 1084: Encoding table transmitter; 1085: Encoding table selector; 1090: Probe-car-mounted machine; 1091: Travel locus transmitter; 1092: Encoder; 1093: Local vehicle position determination section; 1094: Encoding table receiver; 1095: Encoding table data; 1096: Travel locus measurement information accumulating section; 1097: Measurement information valid/invalid determination section; 1098: Sensor information collector; 1101: GPS antenna; 1102: Gyroscope; 1103: Sensor X; 1104: Sensor Y; 1105: Sensor Z; 1106:. Sensor A; 1107: Sensor B; 1108: Sensor C

### BEST MODE FOR CARRYING OUT THE INVENTION

Embodiments of the application will be described referring to drawings.

### FIRST EMBODIMENT

Concerning the first embodiment of the invention, a method of generating gray scale information is described below.

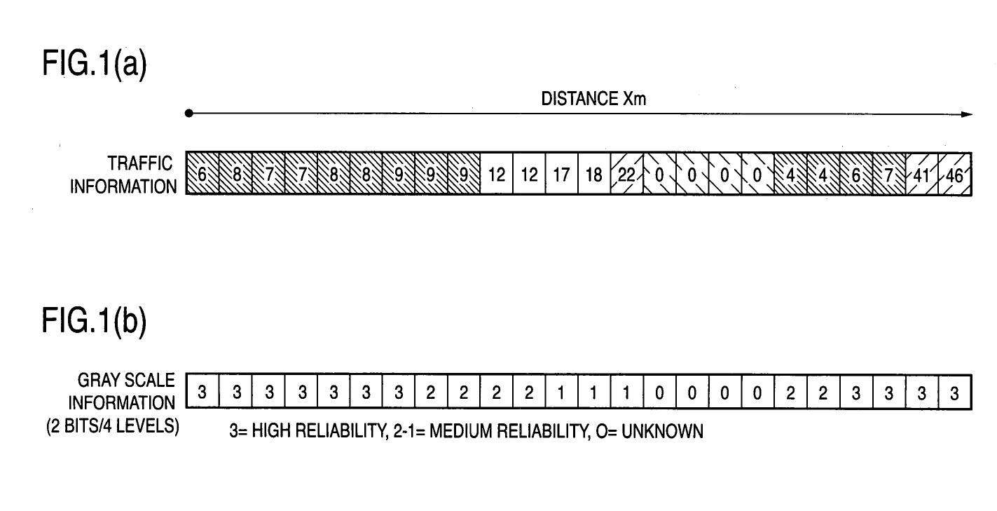

As shown in FIGS. 1A and 1B, traffic information such as congestion information, travel time information and speed information is presented in traffic information representing traffic information changing along a road in the state volume of sampling points (state volume of distance quantization unit) (FIG. 1A) and gray scale information representing the reliability of the state volume of each sampling point (FIG. 1B). Set interval of said sampling points is not necessarily the same for the state volume of traffic information and gray scale information. For example, gray scale information on a single point may be defined for a plurality of sampling points of state volume, or separate number of sampling points may be specified for the state volumes and gray scale information in the same section, without departing from the object of the invention.

In this example, gray scale information is represented in four levels (two bits). A state having the highest reliability is represented by 3, followed by 2, 1 as the reliability becomes lower. 0 represents a faulty vehicle sensor or an “unknown” state where information is absent.

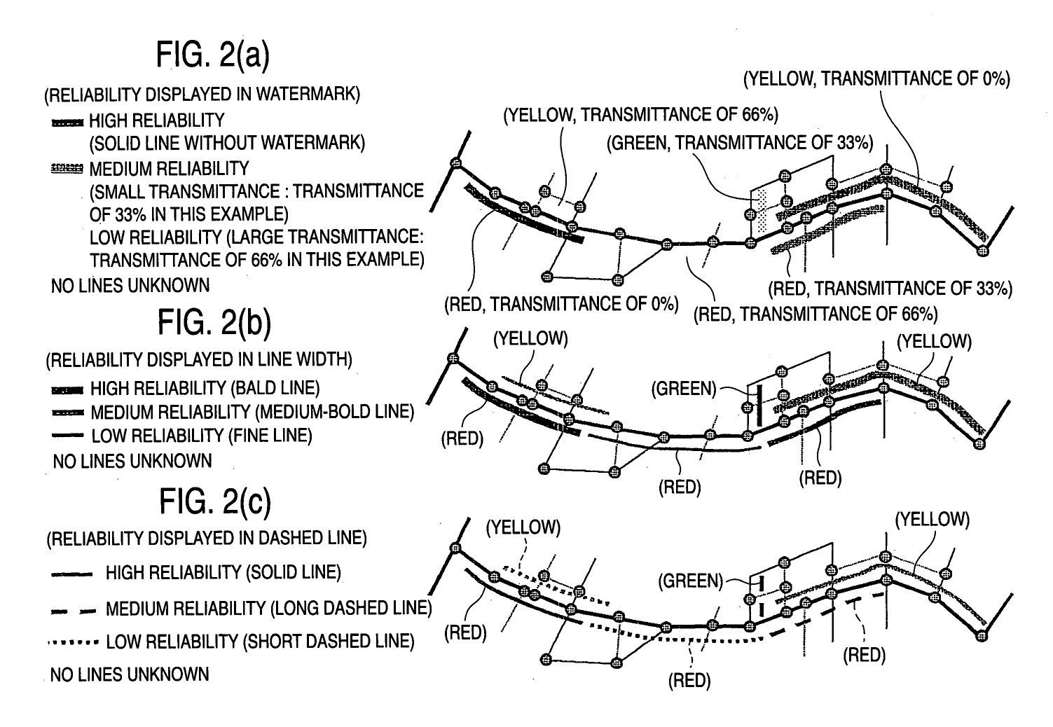

Based on the information, congestion of a road is displayed on the map by using color lines as shown in FIGS. 1A through 2C. In FIGS. 1A through 3C, a section where the vehicle speed representing the state volume of distance quantization unit is 10 km/h or below appears in red, 10 to 20 km/h in yellow, and 20 km/h or above in green. In FIG. 2A, in case the gray scale information representing the reliability of the state volume is 3, a color transmittance of 0 percent is used. In case the gray scale information is 2, a color transmittance of 33 percent is used. In case the gray scale information is 1, a color transmittance of 66 percent is used. In FIGS. 2A through 2C, congestion is separately displayed for the up line and down line. Color lines to represent congestion are not used in an unknown section.

In FIG. 2B, in case the gray scale information representing the reliability of state volume is 3, a bold line is used. In case the gray scale information is 2, a medium bold line is used. In case the gray scale information is 1, a fine line is used.

In FIG. 2C, in case the gray scale information is 3, a solid line is used. In case it is 2, a long dashed line is used. In case it is 1, a short dashed line is used.

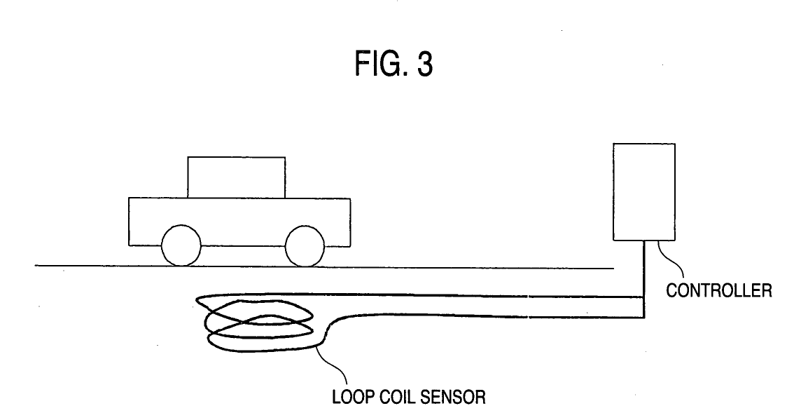

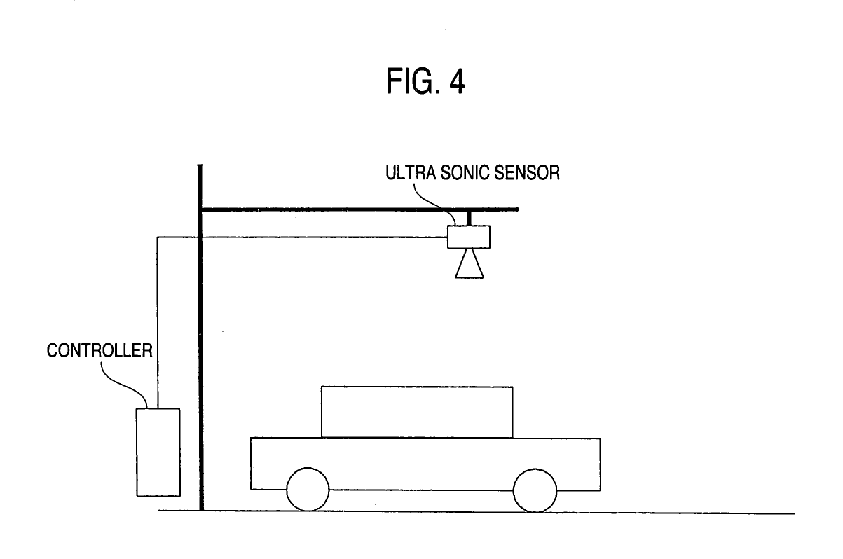

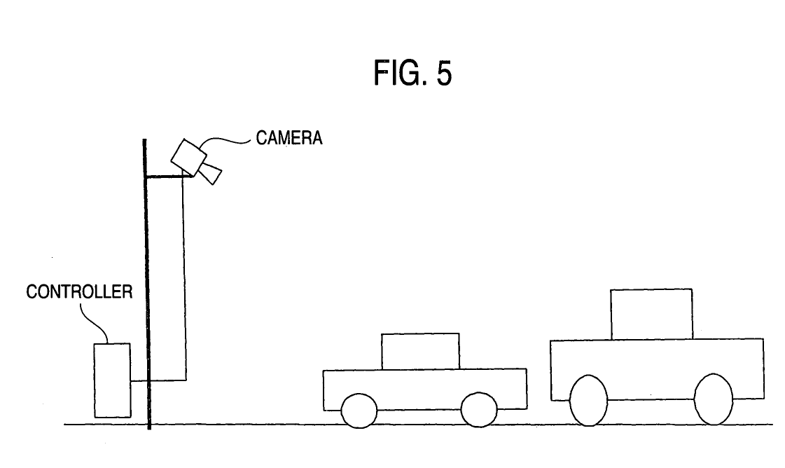

Factors which determine the value of gray scale information includes the following:
Even for the same traffic information (congestion, travel time, etc.), the value of gray scale information of a road where sensors are densely installed is high; the value of gray scale information drops as the density of sensors becomes lower.
Even for the same traffic information, the value of gray scale information is higher when the sensor used to determine the traffic is more accurate; the value of gray scale information drops as the sensor accuracy becomes lower. The sensor may be a loop coil sensor (FIG. 3), an ultrasonic sensor (FIG. 4) or an image sensor (FIG. 5). The loop coil sensor (FIG. 3) counts the number of vehicles which pass over the sensor but cannot identify the vehicle types, which means the sensor accuracy is low. The image sensor (FIG. 5) photographs a traveling vehicle with a camera and processes a shot image to identify the vehicle speed, vehicle type, number of vehicles, and, as required, a particular vehicle by way of its license plate, which means that the sensor accuracy is high. The ultrasonic sensor emits an ultrasonic wave from above a vehicle to a road surface and used the reflected wave to measure the height of the target vehicle. Thus the ultrasonic sensor can determine the number of vehicles and vehicle types. Its accuracy is medium when compared with an image sensor and a loop coil sensor.
Even for the same traffic information, the value of gray scale information is higher when the variations in the nearest trend are small; the value of gray scale information drops as the variations become larger. The “variations in the nearest trend” includes, for example, a variation in the length of congestion at the measurement point. In case the length of congestion at the measurement point gradually changes in a rushing traffic for home, variations in the trend are small. In case the length of congestion greatly changes with time, such as congestion caused by short-time construction and parking/stopping of a large vehicle, variations in the trend are large.
Even for the same traffic information, the value of gray scale information is higher when the variations in the past statistics are small; the value of gray scale information drops as the variations become larger.
Even for the same traffic information estimated based on the detection result of a sensor, the value of gray scale information is higher when the difference from the probe information (information such as a travel speed collected from a traveling vehicle which serves as a probe) is small; the value of gray scale information drops as the difference becomes larger.
Even for the same traffic information, the value of gray scale information is higher when the variations in the past statistics values are small; the value of gray scale information drops as the variations become larger. For the statistical traffic information, the value of gray scale is determined based on a standard deviation.
Even for the same estimated information in the absence of information where information detected by a sensor is not available, the value of gray scale information is higher when the algorithm of the calculation method is highly accurate while accompanied by simulation; the gray scale information value is low when the algorithm of the calculation method is of low accuracy based on a simple assumption from the preceding and subsequent values.
Even for the same prediction information (trend prediction) which predicts traffic in the near future from a trend, the value of gray scale information is higher when the variations in the nearest trend are small; the value of gray scale information drops as the variations become larger.
Even for the same prediction information (statistical prediction) which predicts traffic in the near future from past statistics, the value of gray scale information is higher when the variations in the past statistics are small; the value of gray scale information drops as the variations become larger.
Even for the same prediction information, the value of gray scale is higher when the past percentage of correct answers is high; the value of gray scale information drops as the percentage becomes lower.
Even for the same probe car measurement information, the value of gray scale is higher when the time which has elapsed since collection of information is short (when data is fresh); the value of gray scale information drops as the time which has elapsed becomes longer.
Even for the same bypath route information, the value of gray scale is higher when the effect of selecting the bypath is very great; the value of gray scale information drops as the effect becomes smaller.

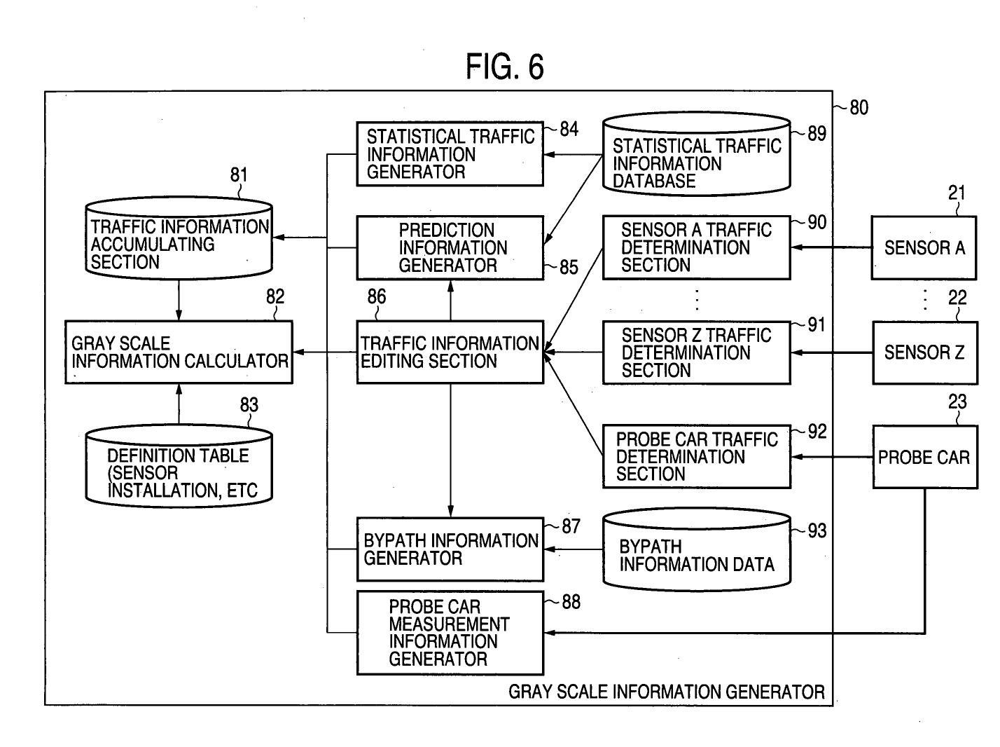

FIG. 6 shows the configuration of a gray scale information generator 80 for generating gray scale information from the above viewpoints.

The gray scale information generator 80 comprises: a sensor A traffic determination section 90 for identifying the operation of a sensor A21 and collecting the information detected by the sensor A21; a sensor Z traffic determination section 91 for identifying the operation of a sensor Z22 and collecting the information detected by the sensor Z22; a probe car traffic determination section 92 for collecting data from a probe car 23 and monitoring the collection state; a traffic information editing section 86 for generating the traffic information at the current point in time; a statistical traffic information database 89 in which past traffic information is accumulated; a statistical traffic information generator 84 for generating statistical traffic information by using the information accumulated in the statistical traffic information database 89; a prediction information generator 85 for generating traffic prediction information in the near future; a bypath information database 93 in which bypath information is accumulated; a bypath information generator 87 for generating bypath information by using the information accumulated in the bypath information database 93; a probe car measurement information generator 88 for generating probe car measurement information by using the information collected from a probe car 23; a traffic information accumulating section 81 for accumulating the traffic information, prediction information, statistical traffic information, bypath information and probe car measurement information generated by each section, a definition table 83 for quantizing the gray scale information; and a gray scale information calculator 82 for generating gray scale information by using the definition table 83.

The traffic information editing section 86 of the gray scale information generator generates the traffic information at the current point in time by using the information collected by the sensor traffic determination sections 90, 91 and the probe car traffic determination section 92. The prediction information generator 85 generates prediction information by using the traffic information at the current point in time generated by the traffic information editing section 86 and the statistical traffic information accumulated in the statistical traffic information database 89. The bypath information generator 87 generates the bypath information on a road currently congested by using the information accumulated in the bypath information database 93.

The statistical traffic information generator 84 statistically analyzes the information accumulated in the statistical traffic information database 89 to generate statistical traffic information. The probe car measurement information generator 88 generates probe car measurement information by using the information collected from the probe car 23. The traffic information prediction information, statistical traffic information, bypath information and probe car measurement information generated by each section are transmitted to the traffic information accumulating section 81 and the gray scale information calculator 82 and are accumulated in the traffic information accumulating section 81.

The gray scale information calculator 82 uses the definition table 83 to generate the gray scale information of the above information.

In the definition table 83 are defined gray scale values corresponding to the installation densities of sensors and sensor types. The gray scale information calculator 82 determines the gray scale value in each section based on the installation density of sensors A to Z and types of the sensors A to Z used by the traffic information editing section 86 to generate traffic information.

In the definition table 83 are defined gray scale values corresponding to times lapsed from the time of measurement. The gray scale information calculator 82 determines the gray scale value in each section based on the time which has elapsed since measurement of data used by the traffic information editing section 86 to generate traffic information.

In the definition table 83 are defined gray scale values corresponding to the variations in the trend of state volume. The gray scale information calculator 82 determines the gray scale value in each section by calculating the trend of the state volume of traffic information and checking the calculated values against the definition table 83.

In the definition table 83 are defined gray scale values corresponding to the statistical variations in the state volume. The gray scale information calculator 82 determines the gray scale value in each section by calculating the statistical variations in the state volume of traffic information in the section from the past to present and checking the calculated values against the definition table 83.

In the definition table 83 are defined gray scale values corresponding to the deviations of the state volumes obtained from the measurement values of a sensor from the state volumes obtained from probe information. The gray scale information calculator 82 calculates the difference between the state volume of traffic information and the state volume of probe car information and checks the calculated values against the definition table 83 to determine the gray scale value of traffic information in each section.

The gray scale information calculator 82 calculates the statistical variations in the state volume of statistical traffic information from the past to present and checks the calculated values against the gray scale values corresponding to the statistical variations in the state volume to determine the gray scale value in each section.

In the definition table 83 are defined gray scale values corresponding to the calculation systems used to estimate a state volume in the absence of information. The gray scale information calculator 82 determines the gray scale value in each section based on the calculation system used by the traffic information editing section 86 to generate traffic information.

The gray scale information calculator 82 calculates the trend of state volume of traffic information and checks the calculated values against the gray scale values corresponding to the variations in the state volume defined in the definition table 83 to determine the gray scale value of state volume of the predicted traffic information generated by the prediction information generator 85.

The gray scale information calculator 82 calculates the statistical variations in the state volume of traffic information in the section from the past to present and checks the calculated values against the gray scale values corresponding to the statistical variations in the state volume defined in the definition table 83 to determine the gray scale value of state volume of the predicted traffic information generated by the prediction information generator 85.

In the definition table 83 are defined gray scale values corresponding to the percentages of correct answers of predicted traffic information. The gray scale information calculator 82 calculates the e percentage of correct answers of predicted traffic information generated by the prediction information generator 85 and determines the gray scale value of the predicted traffic information based on the calculated value.

In the definition table 83 are defined gray scale values corresponding to the numbers of sampling probe cars. The gray scale information calculator 82 determines the gray scale value of probe car measurement information based on the number of samples used by the probe car measurement information generator 88 to generate probe car measurement information.

The gray scale information calculator 82 determines the gray scale value of probe car measurement information based on the time which has elapsed since measurement of probe car data used by the probe car measurement information generator 88 to generate probe car measurement information.

In the definition table 83 are defined gray scale values corresponding to the time reduced when a bypath is used. The gray scale information calculator 82 determines the gray scale value of the bypath information based on the time reduced when a bypath is used in the bypath information generated by the bypath information generator 87.

In this way, the gray scale information generator 80 generates the gray scale information of traffic information, prediction information, statistical traffic information, bypath information and probe car measurement information.

In case only the gray scale information of some information items of the traffic information, prediction information, statistical traffic information, bypath information and probe car measurement information is to be generated, the gray scale information generator 80 may comprise only the related blocks.

### SECOND EMBODIMENT

Concerning the second embodiment of the invention, a case is described below where gray scale information is utilized in the setting of link cost used to perform path search.

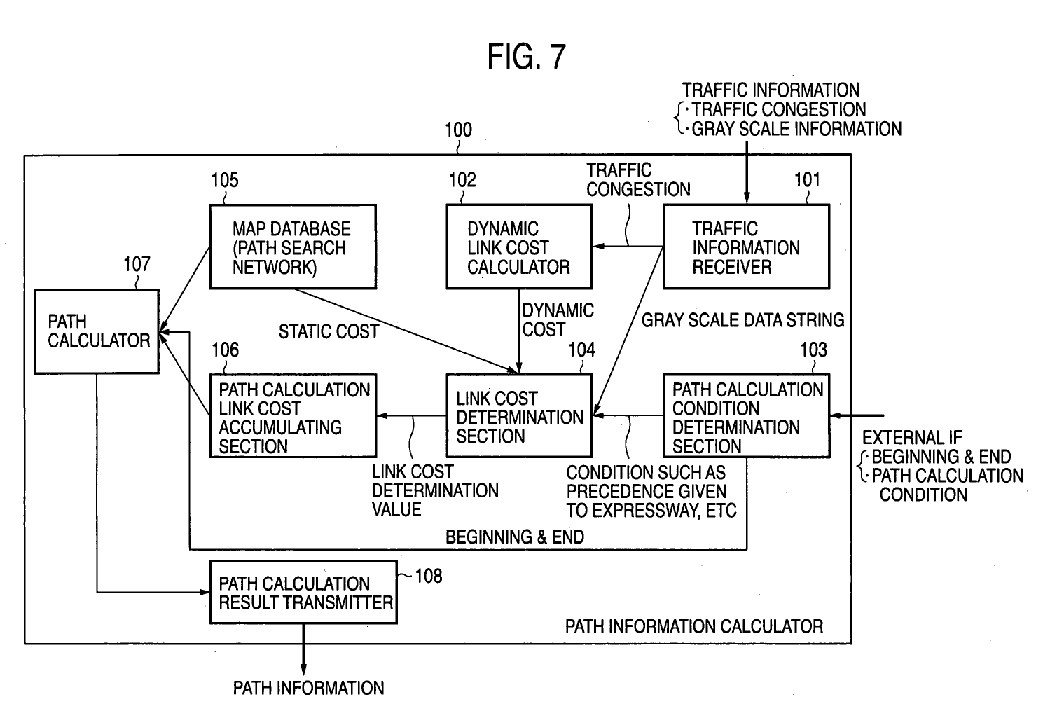

FIG. 7 shows a configuration of a path information calculator 100 in car navigation apparatus or path provision apparatus which receives, as traffic information, the state volume of traffic congestion and the gray scale information representing its reliability and outputs path information.

The path information calculator 100 comprises: a traffic information receiver 101 for receiving traffic information; a dynamic link cost calculator 102 for calculating the dynamic link cost of each link from traffic congestion; a map database 105 for providing map data; a path calculation condition determination section 103 for determining the path calculation condition based on the information input from an external interface; a link cost determination section 104 for determining the link cost of each link by using the gray scale information; a path calculation link cost accumulating section 106 for accumulating the determined link cost; a path calculator 107 for performing path calculation from a beginning to an end by using the accumulated link cost; and a path calculation result transmitter 108 for transmitting the path calculation result as path information.

The traffic information receiver 101 of the path information calculator 100 receives the state volume of traffic congestion and the gray scale information representing its reliability and outputs the state volume of traffic congestion to the dynamic link cost calculator 102 and a bit string of gray scale to the link cost determination section 104.

To the path calculation condition determination section 103 are input, from an external interface (a man-machine interface (path condition setting screen) for car navigation apparatus; a receiver of a path calculation request command for path provision apparatus), the information on the beginning and end of a path to be obtained and the information indicating the conditions for path calculation (such as expressway is given precedence or not, frequency of right/left turn). The path calculation condition determination section 103 outputs the information on the beginning and the end to the path calculator 107 and the path calculation condition to the link cost determination section 104.

The dynamic link cost calculator, receiving the information on traffic congestion, calculates the dynamic link cost of each link changing with time which is caused by congestion and outputs the calculated value to the link cost determination section 104.

The link cost determination section 104 acquires, from the map database (or a path search network) 105, the static link cost of each link not changing with time which is caused by a link length, and changes the distribution ratio of the static link cost to the dynamic link cost by using the gray scale information, thereby calculating the link cost of each link. The calculation expression is as follows:
Link cost=((Gi/Gmax)×dynamic link cost)+((1−(Gi/Gmax)×static link cost)

where Gi is the gray scale value of the pertinent section, and Gmax the maximum value of gray scale (Gmax (high reliability)=3, Gmin (unknown)=0 in the example shown in FIGS. 1A and 1B).

The link cost determination section 104 further changes the link cost to accommodate the path calculation condition, such as weighting an expressway in case an expressway is given precedence.

The link cost of each link calculated by the link cost determination section 104 is accumulated in the path calculation link cost accumulating section 106.

The Path calculator 107 acquires a plurality of paths from the beginning to the end from the map database 105. The path calculator 107 then reads the link cost of each route from the path calculation link cost accumulating section 106, calculates the overall link cost of each path from the beginning to the end, and selects a path whose overall link cost is the smallest. The Path calculation result transmitter 108 transmits the path information selected by the path calculator 107.

In this way, by changing the distribution ratio of the static link cost to the dynamic link cost by using the gray scale information, it is possible to generate a link cost used to acquire appropriate path information.

### THIRD EMBODIMENT

Concerning the third embodiment of the invention, a case is described below where gray scale information is used as means for measuring the information value of traffic information.

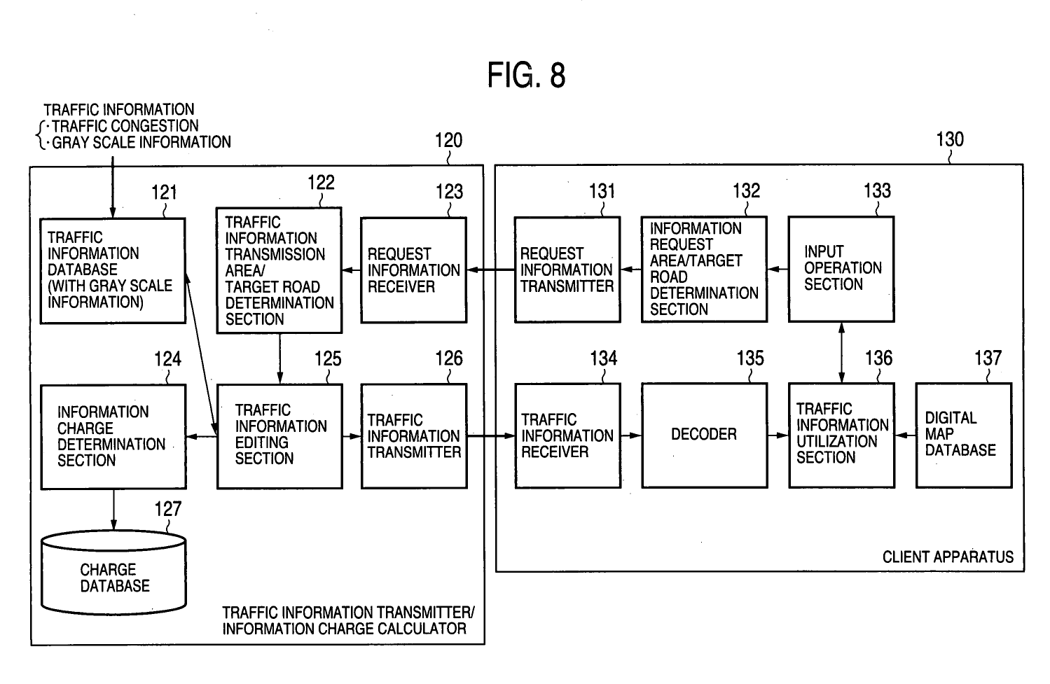

FIG. 8 shows a system comprising a traffic information transmitter/information charge calculator 120 which provides traffic information on a chargeable basis and client apparatus 130 which receives chargeable traffic information. The traffic information transmitter/information charge calculator 120 provides traffic information based on a request by the client apparatus 130. The change for the traffic information is calculated based on the gray-scale information appended to the traffic information.

The traffic information transmitter/information charge calculator 120 comprises: a request information receiver 123 for receiving a traffic information request from the client apparatus 130; a traffic information transmission area/target road determination section 122 for determining the area and target road of the traffic information requested by the client apparatus 130, a Traffic information database 121 in which traffic information data with gray scale information appended is accumulated; a traffic information editing section 125 for reading the traffic information on the pertinent area and target road from the traffic information database 121 and editing the read information; a traffic information transmitter 126 for transmitting the edited traffic information to the client apparatus 130; an information charge determination section 124 for determining the charge for the traffic information to provide to the client apparatus 130 based on the gray scale information; and a chare database 127 in which charge data is accumulated.

The client apparatus 130 comprises: an input operation section 133 to which the user inputs data; an information request area/target road determination section 12 for determining the area and target road of traffic information; a request information transmitter for issuing a request for traffic information to the traffic information transmitter/information charge calculator 120; a traffic information receiver for receiving traffic information from the traffic information transmitter/information charge calculator 120; a decoder 135 for decoding the received traffic information; a traffic information utilization section 136 for utilizing traffic information; and a digital map database 137.

The traffic information transmitter/information charge calculator 120 of this system accumulate as required the state volume of traffic congestion and the gray scale information indicating its reliability into the traffic information database 121. Receiving a request for traffic information from the client apparatus 130, the traffic information transmitter/information charge calculator 120 identifies the area and target road of traffic information requested by the client apparatus 130. The traffic information editing section 125 reads the traffic information of the pertinent area from the traffic information database 121. The traffic information editing section 125 transmits the traffic information data and the attached gray scale information to the information charge determination section 124 as well as edits the traffic information and provides the edited information to the client terminal 130 via the traffic information transmitter 126.

Receiving the traffic information and gray scale information, the information charge determination section 124 determines the information charge by using the following expression:
Information charge=Σ[(Gi/Gmax)×Cost(Ti)]

where Gi is the gray scale value of the pertinent section, Gmax the maximum value of gray scale, and Cost(Ti) is the basic charge for traffic information Ti.

The information charge determination section 124 registers thus determined information charge to a charge database 127.

The client apparatus 130 decodes the traffic information provided by the traffic information transmitter/information charge calculator 120 and uses the decoded information.

In this way, the higher the accuracy of traffic information is, the higher the information charge becomes larger, and the lower the accuracy is, the information charge becomes smaller in this system. This provides a reasonable charge system.

While the traffic information is represented as the state volume at a sampling point (state volume of distance quantization unit), the invention is also applicable to traffic information otherwise represented.

### FOURTH EMBODIMENT

Concerning the fourth embodiment of the invention, a case is described below where the difference of the state volume of traffic information from usual is displayed by way of gray scale information.

When the user can acquire the information “whether the road is more congested or less congested than usual” on the road which he/she uses for commuting and whose congested state is known to him/her, it is possible to determine whether a natural congestion is there for which the flow of cars can be predicted from the experience, or an abrupt congestion is there which the user cannot predict. This greatly helps the user select a path.

Events including an accident, construction, control and road abnormality which could lead to an abrupt congestion is generally difficult to collect by using a sensor. A probe car can measure an extremely precise travel time. Thus, it is possible o acquire an alienation volume from the normal traffic fro the traffic information collected using a probe car. It is possible to detect an abrupt congestion from the alienation volume (note that the cause cannot be located).

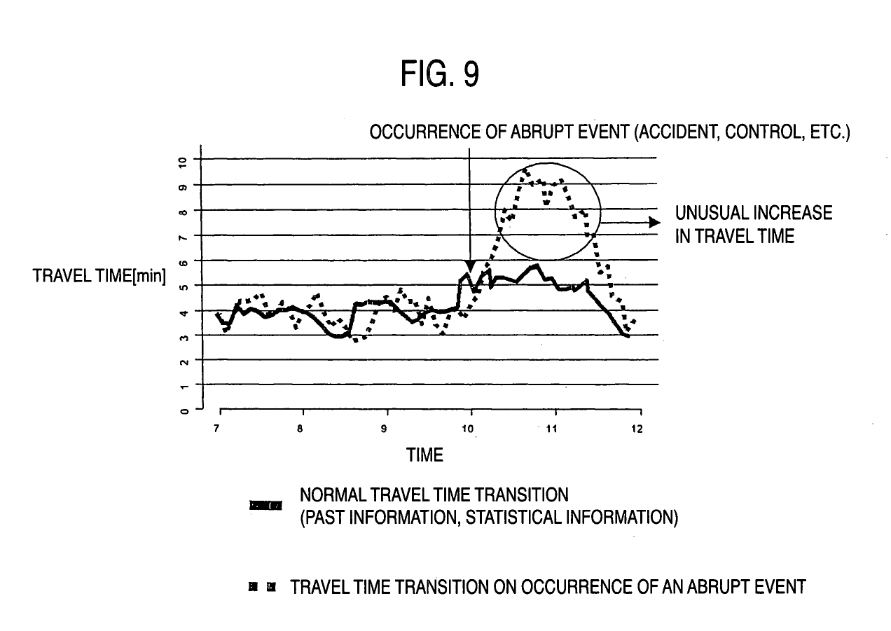

FIG. 9 shows a graph displaying a measurement time on its horizontal axis and a travel time on its vertical axis, where a transition of travel time in normal traffic is presented in solid lines and transition of travel time in the presence of an abrupt event is presented in dashed lines. When an abrupt event takes place, an unusual increase in travel time is observed.

According to the traffic information display method of this embodiment, the magnitude of alienation of measured travel time data from the past average value of travel time is obtained as attribute information, and the travel time measurement data and gray scale information indicating its attribute information are presented altogether.

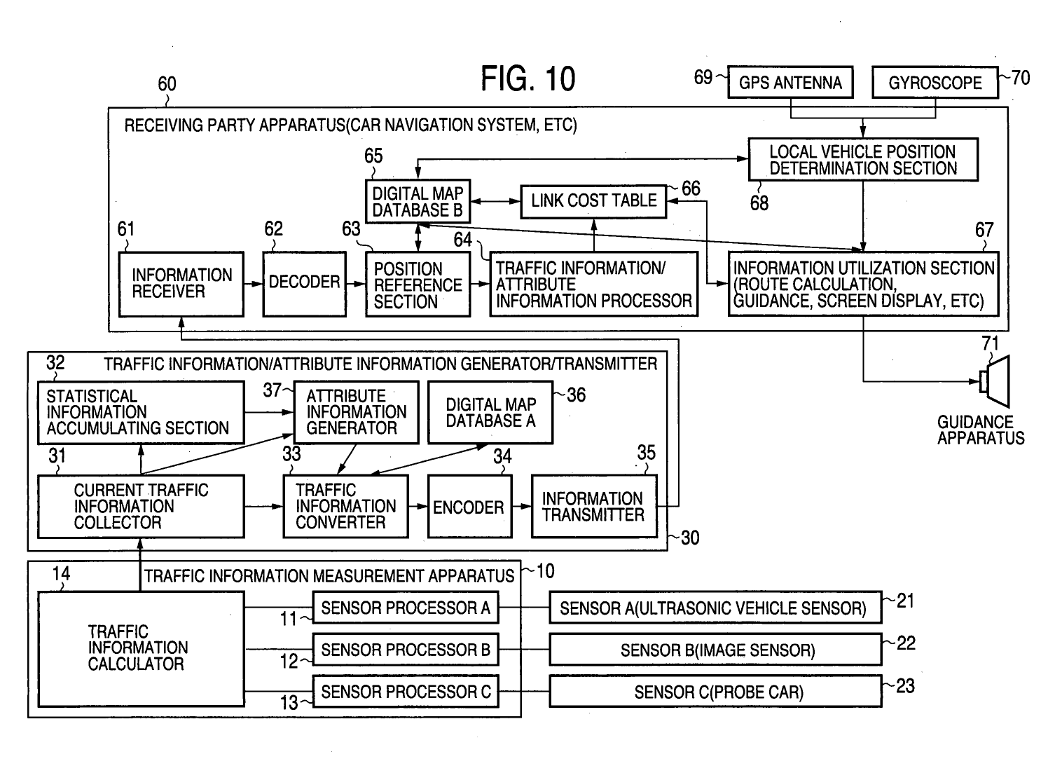

FIG. 10 shows the configuration of a center which generates and provides the measurement information and gray scale information and a receiving party which receives and utilizes this traffic information. The center comprises traffic information measurement apparatus 10 for measuring traffic information by using a sensor A (ultrasonic vehicle sensor); a sensor B (image sensor) 22 and a sensor C (probe car) 23, and a traffic information/attribute information generator/transmitter 30 for generating traffic information and gray scale information from measurement information and transmits the resulting information.

The traffic information measurement apparatus 10 comprises a sensor processor A11, a sensor processor B12 and a sensor processor C13 which process data acquired from the sensors 21, 22, 23, and a traffic information calculator 14 for calculating measurement information of traffic information by using the data processed by the sensor processors 11, 12, 13 and outputting to a traffic information/attribute information generator/transmitter 30 the calculated information together with the information indicating the target section.

The traffic information/attribute information generator/transmitter 30 comprises: a current traffic information collector 31 for collecting measurement information and target section information from the traffic information measurement apparatus 10; a statistical information accumulating section 32 for accumulating the collected measurement information and target section information; an attribute information generator 37 for calculating the attribute information of the measurement information to generate gray scale information; a traffic information converter 33 for converting the measurement information, gray scale information and target section information to a form suited for encoding; an encoder 34 for encoding the converted data; an information transmitter 35 for transmitting the encoded traffic information, gray scale and target section information; and a digital map database 36 referenced by the traffic information converter 33.

Receiving party apparatus such as car navigation apparatus comprises an information receiver 61 for receiving the information provided by the traffic information transmitter 30; a decoder 62 for decoding the received information to reproduce traffic information, gray scale information and target section information; a digital map database 65; a link cost table 66 in which the link cost of each link is described; a position reference section 63 for referencing the digital map database 65 to identify the target section of traffic information; a traffic information/attribute information processor 64 for updating the description of the link cost table 66 based on the traffic information and gray scale information; a local vehicle position determination section 68 for determining the local vehicle position by using a GPS antenna 69 and a gyroscope 70; an information utilization section 67 for displaying a map around the local vehicle position or a path guidance with congestion information attached, or performing a route search to the destination; and a guidance apparatus 71 for performing voice guidance.

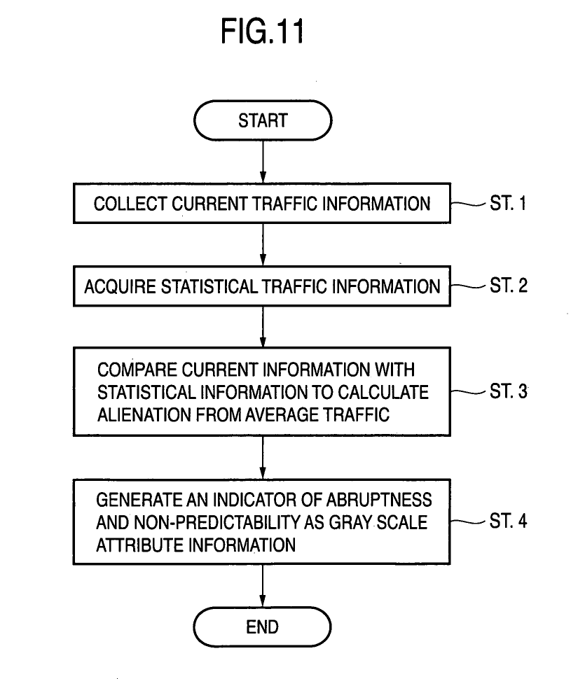

The attribute information generator 37 of the Traffic information/attribute information generator/transmitter 30 generates gray scale information in accordance with the procedure shown in FIG. 11.

The attribute information generator 37 acquires the current measurement information collected by the current traffic information collector 31 from the traffic information measurement apparatus 10 (step 1), acquires the past measurement information (statistical information) of the same target section from the statistical information accumulating section 32 (step 2), calculates how far the current measurement information is alienated from the average of statistical information (step 3), and sets a value corresponding to the magnitude of alienation as gray scale information representing the attribute information of the current measurement information (step 4).

For example, in case the attribute information of travel time is displayed in gray scale information of two bits and four levels, a average value and a standard deviation σ are calculated and gray scale information is set as follows in accordance with the magnitude of alienation of the current measurement value from the average value of travel time:

When alienation of the current measurement value from the average value is less than 1 σ: 0

When alienation of the current measurement value from the average value is 1 σ or more and less than 2 σ: 1

When alienation of the current measurement value from the average value is 2 σ or more and less than 3 σ: 2

When alienation of the current measurement value from the average value is 3 σ or more: 3

When it is assumed that a traffic flow is stopped due to failure to measure data 3

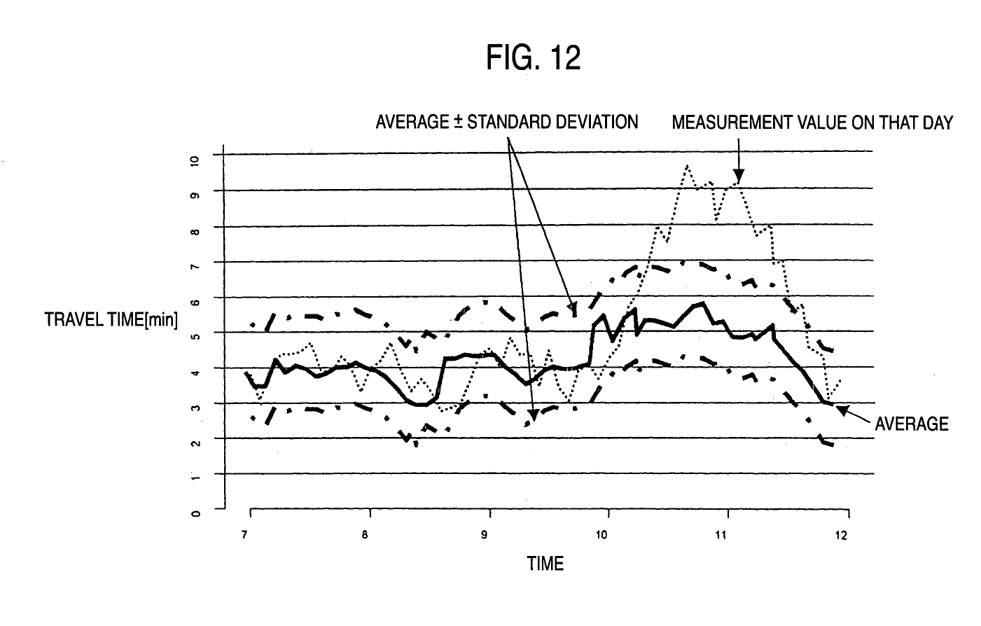

FIG. 12 schematically shows average values of statistical information of travel time (solid lines), measurement values of travel time on that day (dotted lines) and a range where gray scale information is displayed as 1 (between alternate long and short dashed lines). This example shows a case where the gray scale information value exceeds 1 when congestion due to an abrupt event takes place. In this way, gray scale information can serve as an indicator to identify whether an abrupt congestion (which even the user familiar with the target section cannot predict the flow of cars) is present in the target section.

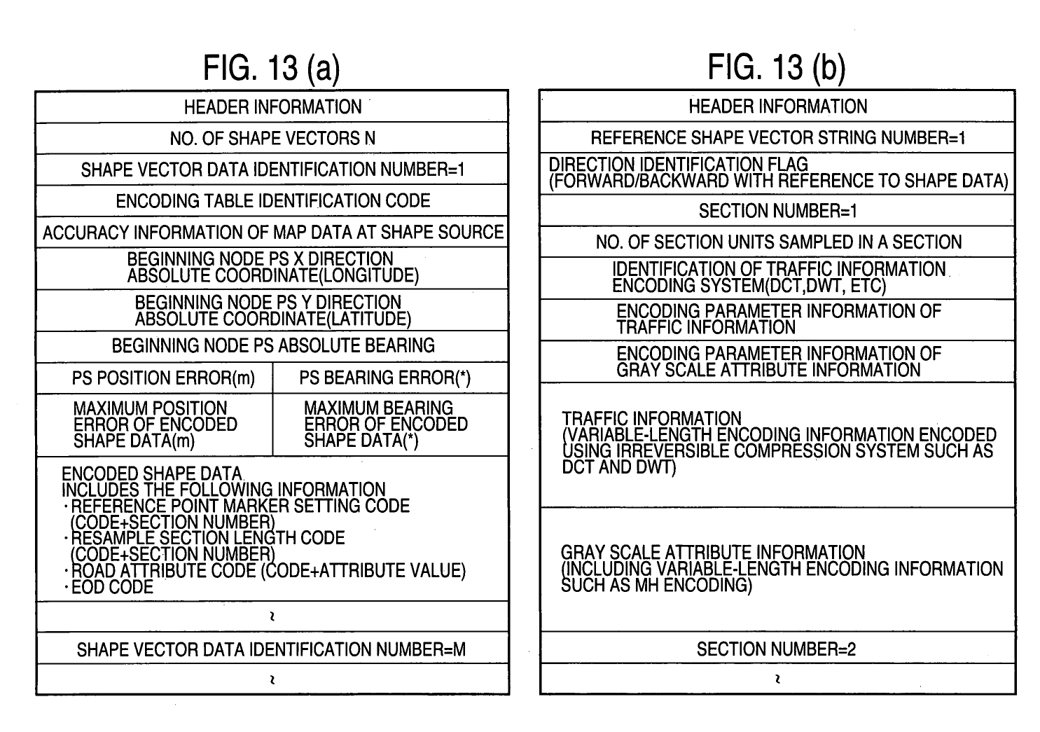

The gray scale information is transmitted, while included in traffic information, to the receiving party apparatus 60. FIGS. 13A and 13B illustrate the data structure of traffic information (FIG. 13B) transmitted from the traffic information/attribute information generator/transmitter 30 and position reference information (FIG. 13A) indicating the target section. The traffic information (FIG. 13B) includes the encoded traffic information data and gray scale information data.

The receiving party apparatus 60 decodes the received data and identifies the target section of traffic information from the position reference information. The receiving party apparatus 60 also writes traffic information and gray scale information into the link cost table 66 to update the link cost. The information utilization section 67 of the receiving party apparatus 60 blink-displays the congestion information on a map around the local vehicle position while setting a shorter blinking interval as the gray scale information value becomes higher and alienation from the statistical information becomes greater. The information utilization section 67 supplies a voice guidance from the guidance apparatus 71 such as “An abrupt congestion is ahead of you (on the route),” in the presence of a congestion with a high gray scale value. The information utilization section 67 adds a penalty cost corresponding to the alienation to the standard link cost for a section which has encountered an abrupt congestion in a path search thus making this road section less attractive.

In this way, by setting the information indicating the degree of alienation from the normal traffic as attribute information of traffic information and providing the gray scale information representing the attribute information together with the traffic data, the driver can avoid a risk of being involved in an unpredictable congestion.

Traffic provided as traffic information may be a travel time, a travel speed, a traffic volume, an occupancy, a congestion rank, or a congestion length.

The gray scale information value may be set based on the comparison with the quartiles obtained by splitting the range from the maximum to minimum values in the statistical information. For example,

When the current measurement value is equal to or smaller than the first quartile 0 (far less congested than usual)

When the current measurement value is between the first and second quartiles 1 (a little less congested than usual)

When the current measurement value is between the second and third quartiles 2 (a little more congested than usual)

When the current measurement value is equal to or greater than the third quartile 3 (far more congested than usual)

Statistical information may be summed by day type (weekday, Saturday, Sunday, 5th, 10th, 15th, 20th, 25th and 30th of each month, event day) or by weather and the current measurement value may be compared with the statistical information whose day type or weather are identical with that of the current measurement value.

The value of gray scale information is meaningful when it is represented in binary notation, “0” indicating an ordinary congestion and “1” indicating an abrupt congestion. By increasing the values used for gray scale information in order to precisely represent an alienation volume, the added value of information is enhanced.

While the traffic information, gray scale information and target section information are encoded and transmitted, encoding is not mandatory. The target section of traffic information may be identified using information other than a shape vector. For example, a road section identifier, an intersection identifier, a link number, an identifier assigned to each tile-shaped segment of a road map, a kilo post installed at a road, a road name, an address, and a ZIP code may be used as position reference information.

### FIFTH EMBODIMENT

Concerning the fifth embodiment of the invention, a system is described below where the receiving party specifies the day type and time zone of the statistical information to be compared with the current information when providing traffic information by using the representation method of the fourth embodiment.

Traffic on the road recognized by the user may pertain to a specific season, day of week, or a specific weather and may differ from the average traffic congestion on the road. This often happens in case the user drives a car only in a specific season or on a specific day of week. In case the user only drove on the road before a big-scale construction started, the user has no idea about the congestion during a big-scale construction. Congestion and wait time in the parking lot of a large shopping mall, department store, station or indoor amusement facility greatly depend on the weather. The traffic around the parking lots greatly differs between a fine day and a rainy day.

The system represents the alienation between the traffic of which the user recognizes the congestion and the current traffic in terms of the attribute information of traffic information. Thus, the user communicates to the information provider the day type, time zone for which the user knows the congestion, or current weather. The information provider collects the statistical information satisfying the conditions from the statistical information to generate reference information and compares the reference information with the current information, thereby generating the attribute information of traffic information.

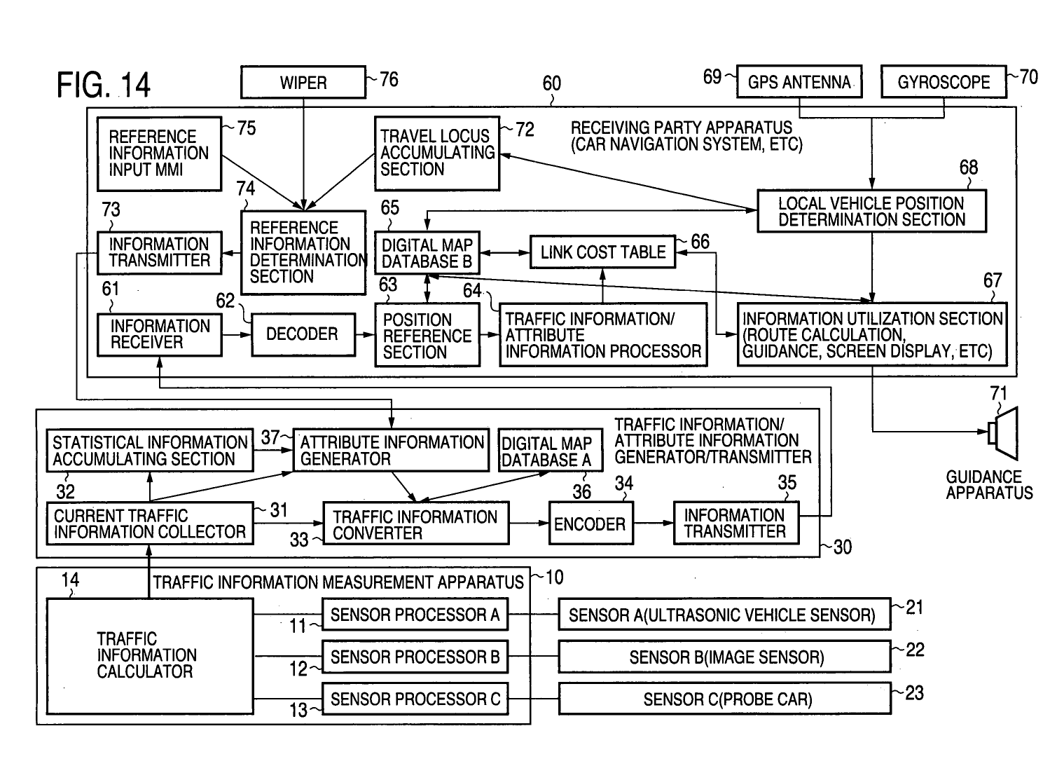

FIG. 14 shows the configuration of the system. The receiving party apparatus 60 comprises: a man-machine interface (MMI) 75 for inputting reference information; a travel locus accumulating section 72 for accumulating a travel locus; a wiper 76 operating in a rainy weather; a reference information determination section 74 for determining the conditions for reference information from the information input from the reference information input MMI 75, the operation of the wiper 76 and past travel locus; and an information transmitter 73 for transmitting the conditions for reference information to the traffic information/attribute information generator/transmitter 30. The other configuration is the same as that of the fourth embodiment (FIG. 10).

The flowchart of FIG. 15 shows the operation procedure of the receiving party apparatus 60 and the traffic information/attribute information generator/transmitter 30.

The reference information determination section 74 of the receiving party apparatus 60 specifies the conditions for reference information based on the information input from the reference information input MMI 75. When the wiper 76 is operating, the reference information determination section 74 specifies a rainy weather as a condition for reference information. From the past travel locus, the reference information determination section 74 obtains the day type and time zone of the past travel history and specifies the day type and time zone as conditions for reference information (step 10). The receiving party apparatus 60 transmits the conditions for reference information to the traffic information/attribute information generator/transmitter 30 (step 11).

The attribute information generator 37 of the traffic information/attribute information generator/transmitter 30 acquires the current measurement information collected by the current traffic information collector 31 from the traffic information measurement apparatus 10 (step 10), selects the statistical information satisfying the specified conditions to generate reference information (step 21), and compares the current information with the average of reference information to calculate alienation from the average (step 22), sets a value corresponding to the magnitude of alienation as gray scale information, and transmits the current information and the gray scale information to the receiving party apparatus 60 (step 23). The receiving party apparatus 60 receives the traffic information and utilizes the information same as in the fourth embodiment (step 12).

In this way, the system provides elaborate traffic information customized to individual experiences of the user. The user acquires, as gray scale information, the information compared with the traffic information whose congestion is familiar to the user, thereby correctly predicting the flow of cars in the current congestion. As a result, appropriate path selection is made possible.

### SIXTH EMBODIMENT

Concerning the sixth embodiment of the invention, a case is described below where the trend of increasing/decreasing traffic is used as attribute information of traffic information and the attribute information is represented in gray scale information.

Configuration of the sending party and the receiving party to implement the traffic information representation method is the same as that in the fourth embodiment (FIG. 10).

The increasing/decreasing trend of traffic is determined base on the comparison with the traffic a certain time ago and is represented in gray scale information. For example, to represent an increase/decrease in the travel time, the current travel time is compared with that 30 minutes ago and gray scale information is displayed:

When the travel time has changed (decreased) by 20 percent or more 0

When the variation in the travel time is between −20 and 0 percent 1

When the variation in the travel time is between 0 and 20 percent 2

When the travel time has changed (increased) by 20 percent or more 3

In this way, by setting the traffic increasing/decreasing trend as attribute information, the user can properly address an abrupt congestion. The user may select an alternate route when the travel time is increasing. The user may stay in the congestion when the travel time is decreasing.

The attribute information of traffic information may be variations such as the increasing/decreasing ratio including “increase/decrease in congestion length,” “increase/decrease in travel speed,” “increase/decrease in unit block (or link) travel time” as well as “occupation ratio of a parking lot” and “wait time in a parking lot.” Such attribute information may be displayed in gray scale information.

### SEVENTH EMBODIMENT

Concerning the seventh embodiment of the invention, a case is described below where the superiority of path information obtained through path search is used as attribute information of the path information and the attribute information is represented in gray scale information.

Car navigation apparatus provides a DRGS (Dynamic Route Guidance System) to present a shortest-time route to the destination. A driver may wish to use a familiar, frequented route as long as the time required is almost the same.

In the method of displaying path information in this embodiment, the shortest-time route is compared with another route (reference route) and the superiority of the shortest-time route over the reference route is displayed in gray scale information, and the shortest-time route information and the gray scale information are provided. The driver may select the shortest-time route in case its superiority is high and may select another route in case its superiority is low.

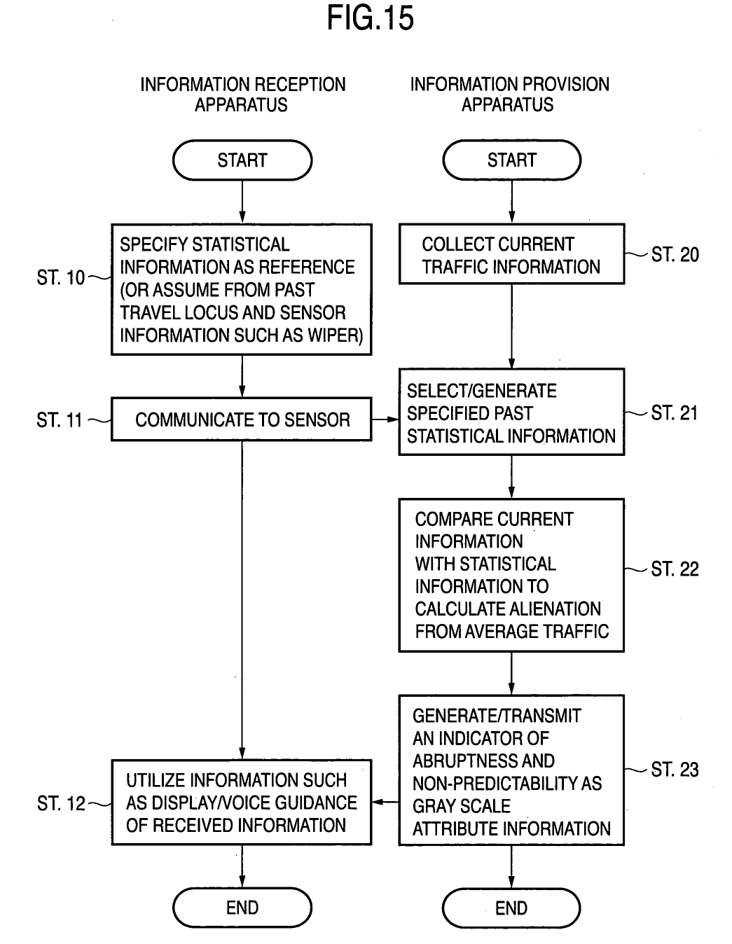

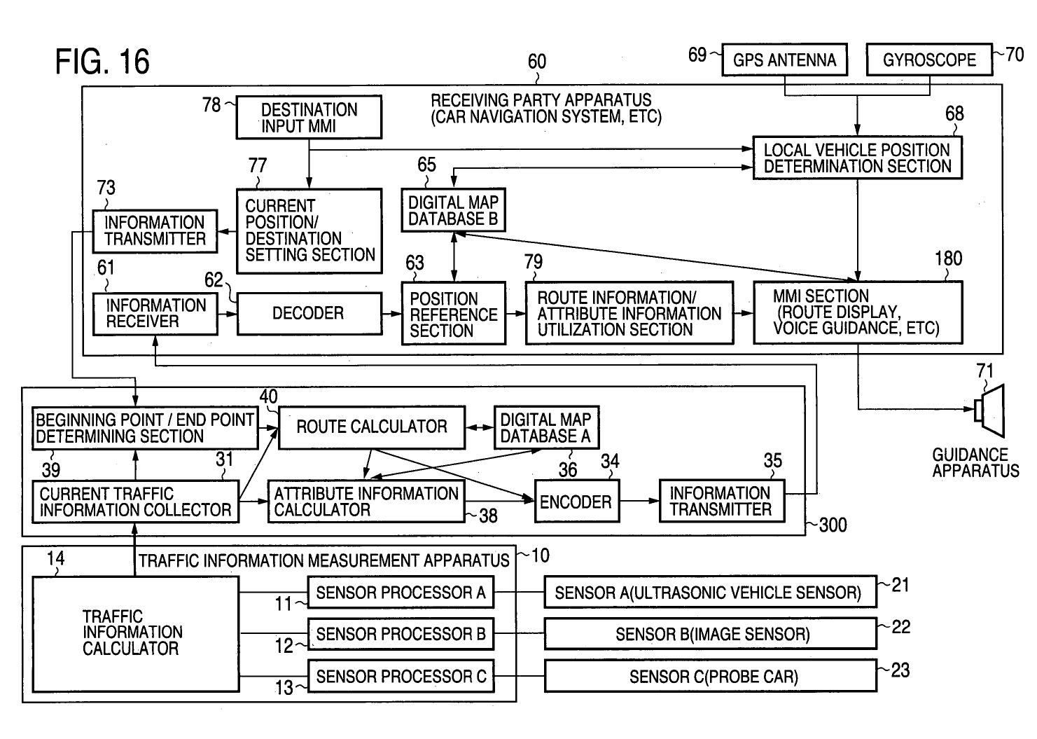

FIG. 16 shows the configuration of a system which provides path information by way of this method. In this example, the center calculates the shortest-time route and the gray scale information and provides the information to the receiving party apparatus, a so-called CDRGS (center-calculation type DRGS). The route/attribute information calculator/transmitter 300 of the center comprises: a beginning/end determination section for determining the beginning and end of path search based on the information on the current position and the destination transmitted from the receiving party apparatus 60; a current traffic information collector 31 for collecting traffic information and target section information from a traffic information measurement apparatus 10; a route calculator 40 for calculating a shortest-time route to the destination; an attribute information calculator 38 for calculating the superiority of the shortest-time route and generating gray scale information; an encoder 34 for encoding the data on the shortest-time route and gray scale information; an information transmitter 35 for transmitting the encoded route provided and the gray scale information; and a digital map database 36.

The receiving party apparatus 60 comprises: an information receiver 61 for receiving the information provided by the route/attribute information calculator/transmitter 300; a decoder 62 for decoding the received information to reproduce route information and traffic information; a digital map database 65; a position reference section 63 for referencing the digital map database 65 to identify the provided route; a route information/attribute information utilization section 79 for processing the provided route information and gray scale information and utilizing the processed information; an MMI 180 for displaying the route information; guidance apparatus 71 for performing voice guidance; a local vehicle position determination section 68 for determining the local vehicle position by using a GPS antenna 69 and a gyroscope 70; an MMI 78 for inputting a destination; a current position/destination setting section 77 for setting a current position and a destination; and an information transmitter for transmitting the information on the current position and the destination to the route/attribute information calculator/transmitter 300.

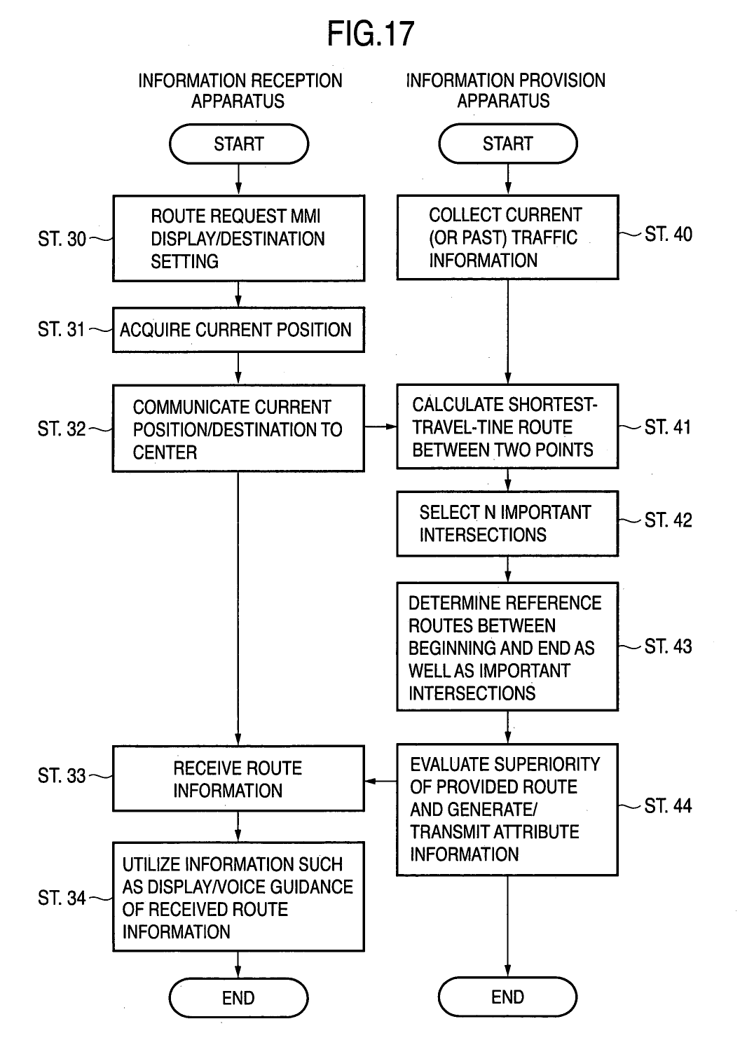

The flowchart of FIG. 17 shows the operation procedure of the receiving party apparatus 60 and the route/attribute information calculator/transmitter 300.

A route request screen is displayed on the receiving party apparatus 60, and a destination is input to the screen (step 30). The current position/destination setting section 77 acquires the current position (step 30), sets the destination and the current position, and transmits the information to the route/attribute information calculator/transmitter 300 (step 32).

The current traffic information collector 31 of the route/attribute information calculator/transmitter 300 collects the current (or past as required) from the traffic information measurement apparatus 10 (step 40). The route calculator 40 references the collected traffic information and calculates the shortest-time route between the specified current position and destination (step 41). The attribute information calculator 38 selects N important intersections on the calculated route (step. 42) and determines the reference route of each section split with the beginning, end and important intersections (step 43).

In case the user has previously registered a route, the route is used as a reference route.

In case no routes are registered, the shortest-distance route is determined as a reference route. When a road is not congested, such as in the nighttime, the shortest-distance route serves as a shortest-time route, which the driver will usually select. Thus, it is reasonable to select a shortest-distance route as a “reference path.”

Another route, for example the Nth route whose travel time between the current position and the destination is Nth shortest may be used as a reference route. Or, another representative route whose path matching ratio with the shortest-time route is below a prespecified value may be used as a reference route.

The attribute information calculator 38 compares the shortest-time route of each section split with the beginning, end and important intersections with the reference route and obtains the superiority of the shortest-time route.

For example, the attribute information calculator 38 sets the reduced travel time as an indicator of superiority and calculates the superiority in each section while using the correspondence of the travel time reduced by traveling on the shortest-time route instead of the reference route to each superiority:

| | |
|---|---|
| Less than 5 minutes | Superiority 0 |
| 5 to 15 minutes | Superiority 1 |
| 15 to 30 minutes | Superiority 2 |
| 30 minutes or more | Superiority 3 |

The attribute information calculator 38 thus generates gray scale information where the superiority values are arranged. The e attribute information calculator 38 then transmits the obtained gray scale information and the information on the shortest-time route to the receiving party apparatus 60 (step 44).

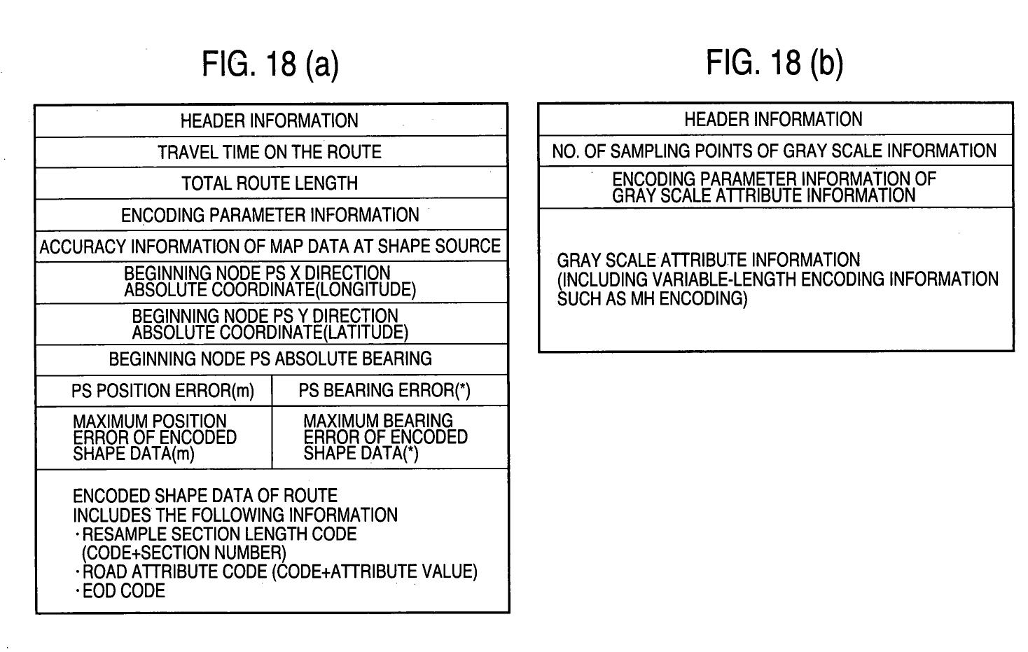

FIGS. 18A and 18B illustrate the data structure of position reference information of route information (FIG. 18A) transmitted from the route/attribute information calculator/transmitter 300 and gray scale information (FIG. 18B) presenting the attribute information of route information.

The position reference information (FIG. 18A) and the gray scale information (FIG. 18B) may be incorporated as a single data item.

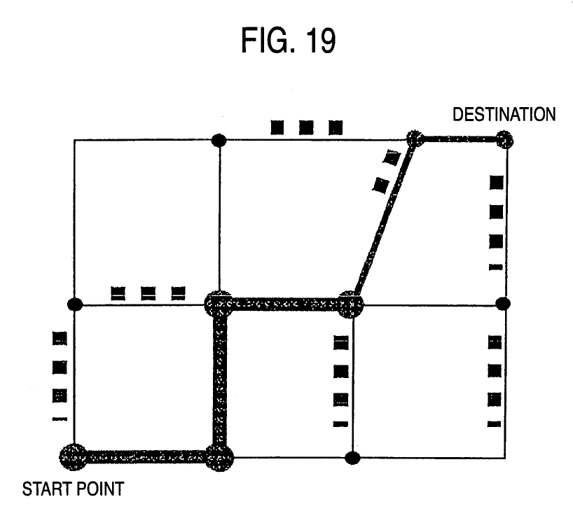

The receiving party apparatus 60, receiving the route information (step 33), uses the position reference information to identify the provided route on a digital map and displays the route on the screen or via voice (step 34). In this practice, as shown in FIG. 19, the receiving party apparatus 60 changes the thickness of a line representing the provided route depending on the gray scale information value of each section. The driver who checks this screen can, for example, determine that the bold line section of the provided route will be followed and the fine line section will be switched to an alternate, frequented route. In FIG. 19, congestion information on each path is displayed in dotted lines.

The provided route may be displayed, same as display in the first embodiment, (FIGS. 2A through 2C), so that the line type (solid line/dashed line) is changed depending on the gray scale values or watermark is changed.

The system thus sets the superiority of route information over the reference route is to attribute information and provides path information represented in route information and attribute information.

The driver who has received this information will select the provided shortest-time route (which matches the shortest-distance route in this time zone) in a time zone the road is not congested, such as in the nighttime.

In a time zone where traffic is increasing (such as morning peak hours), the entire road network is gradually congested (that is, an alternate route is also getting congested). Even when a shortest-time route to replace the shortest-distance route is available, there is no large difference in the actual travel time. This drops the superiority of the shortest-time route. In such a case, the driver will select his/her familiar route rather than the “route on which the/she is a stranger”.

There exist, though not often, an abrupt event or a situation that the traffic is unusually dense (sparse). In this case, the superiority of the provided route is self-evident so that the driver will select the route while running some risk.

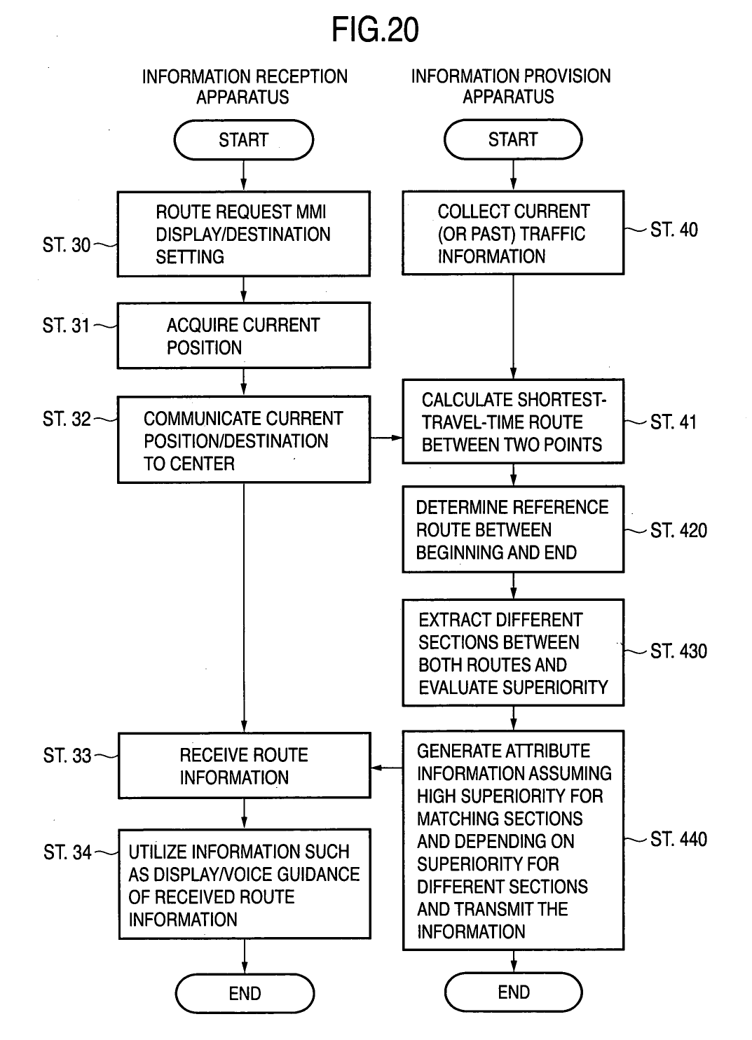

Evaluation of the superiority of the shortest-time route over the reference route may be made using the procedure of FIG. 20. In this procedure, steps up to when the route calculator 40 of the route/attribute information calculator/transmitter 300 calculates the shortest-time route between the specified current position and destination (step 41) are same as FIG. 17. The attribute information calculator 38 determines the reference route between the beginning and the end (step 420) and extracts the sections different between both routes and evaluates the superiority of the shortest-time route (step 430). Superiority of the sections where both routes match each other is assumed to be large. For the different section, the superiority is calculated in the same procedure as FIG. 17 and gray scale information where the superiority values are arranged is generated. The obtained gray scale information as well as the shortest-time route information are transmitted to the receiving party apparatus 60 (step 440).

In case the shortest-time route and the reference route have more common sections, the procedure is employed to reduce the load of superiority calculation.

As an indicator of superiority, the travel tie reduction ratio (%) may be used instead of the reduced travel time. In this case, superiority is set so that the rate of travel time reduced by traveling on the shortest-time route instead of the reference route will be:

| | |
|---|---|
| Less than 5% | Superiority 0 |
| 5 to 10% | Superiority 1 |
| 10 to 20% | Superiority 2 |
| 20% or more | Superiority 3 |

The probability of reaching the destination earlier by traveling on the shortest-time route instead of the reference route (wining percentage) may be set as the superiority indicator. Traffic information generally has variations. Considering the variations, the route provided as the shortest-time route is not necessarily the fastest route. The winning percentage represents the probability that the provided route will win. When the winning percentage is used as the indicator of superiority, superiority is set as follows:

| | |
|---|---|
| In case the winning percentage is 50 to 55% | Superiority 0 |
| In case the winning percentage is 55 to 60% | Superiority 1 |
| In case the winning percentage is 60 to 70% | Superiority 2 |
| In case the winning percentage is 70% or more | Superiority 3 |

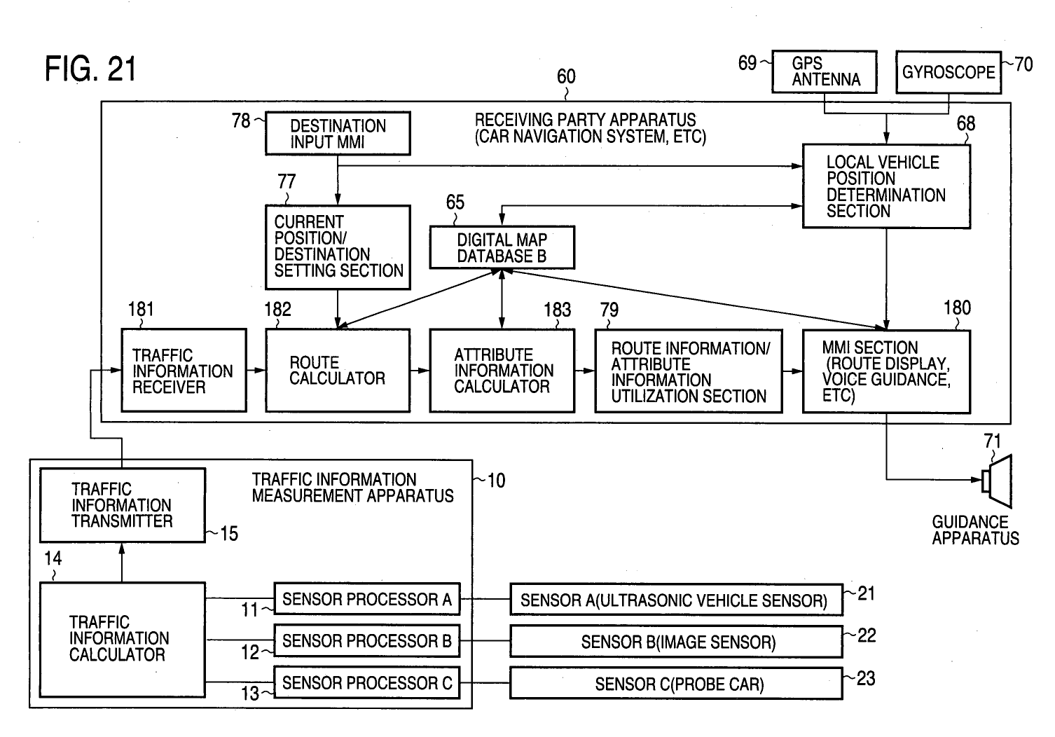

FIG. 21 shows the configuration of LDRGS (terminal-calculation DRGS) where the receiving party apparatus which has received traffic information from the center calculates the shortest-time route and gray scale information.

The traffic information calculator 10 of the center comprises a traffic information transmitter 15 for transmitting information to the receiving party apparatus 60.

The receiving party apparatus 60 comprises: a traffic information receiver 181 for receiving traffic information; a route calculator 182 for calculating the shortest-time route to the destination; and an attribute information calculator 183 for calculating the superiority of the shortest-time route to generate gray scale information. Same as the receiving party apparatus shown in FIG. 16, the receiving party apparatus 60 further comprises: a digital map database 65; a route information/attribute information utilization section 79; an MMI section 180; guidance apparatus 71, a GPS antenna 69; a gyroscope 70; a local vehicle position determination section 68; a destination input MMI 78, and a current position/destination setting section 77.

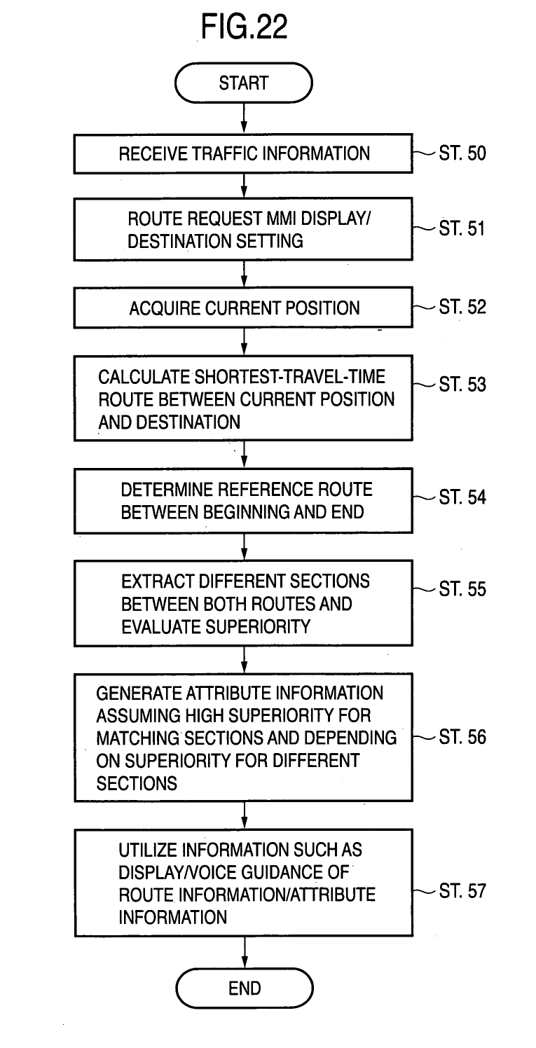

FIG. 22 shows the operation procedure of the receiving party apparatus 60. In this case, the operation made by the route calculator and the attribute information calculator of the route/attribute information calculator/transmitter 300 in CDRGS (FIG. 16) is made by the route calculator 182 and the attribute information calculator 183 of the receiving party apparatus 60 inside the receiving party apparatus 60.

In this way, by setting the superiority of route information over the reference route to attribute information and providing path information represented by route information and attribute information, the driver can properly select a path.

### EIGHTH EMBODIMENT

The traffic information providing system of the eighth embodiment of the invention provides the state volume of traffic information changing along a road and mask bit information indicating the validity of the state volume.

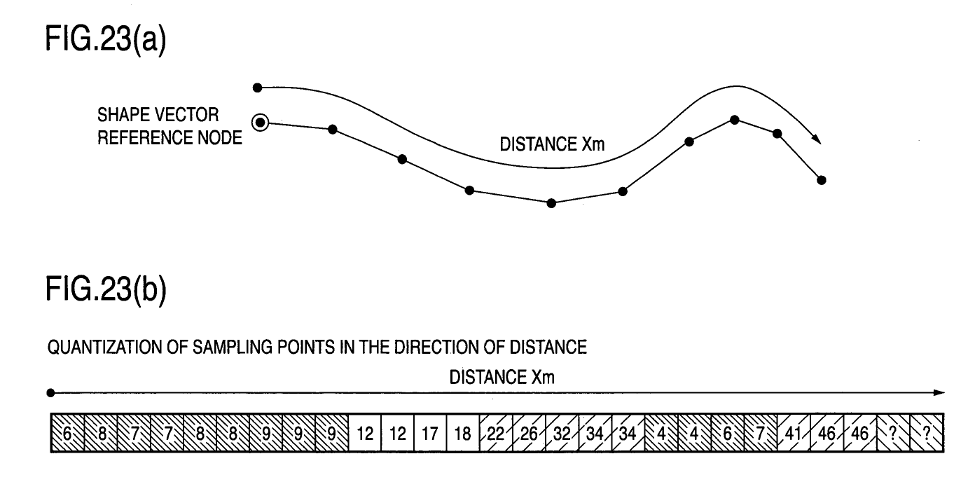

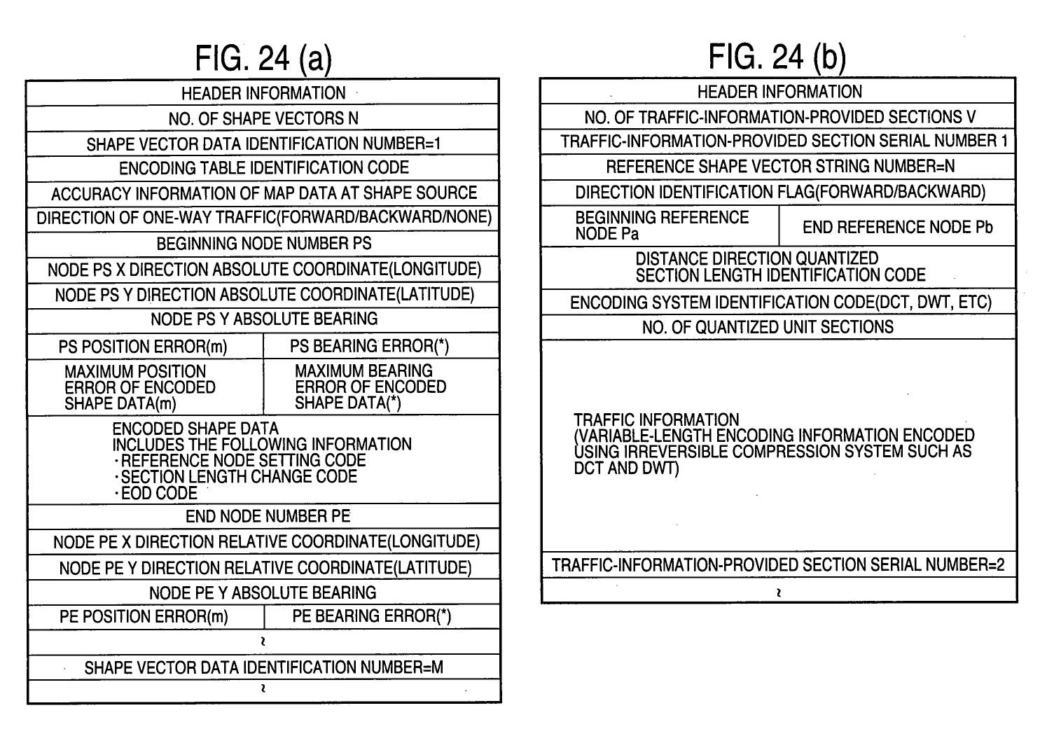

Mask bit information is, as shown in FIGS. 15A through 25C, information which indicates that the state volume of traffic information in the quantization unit (distance quantization unit) obtained by equidistantly segmenting a shape vector (road) is valid or invalid and is represented by 0 or 1, where 0 means that traffic information is invalid and 1 means that traffic information is valid.

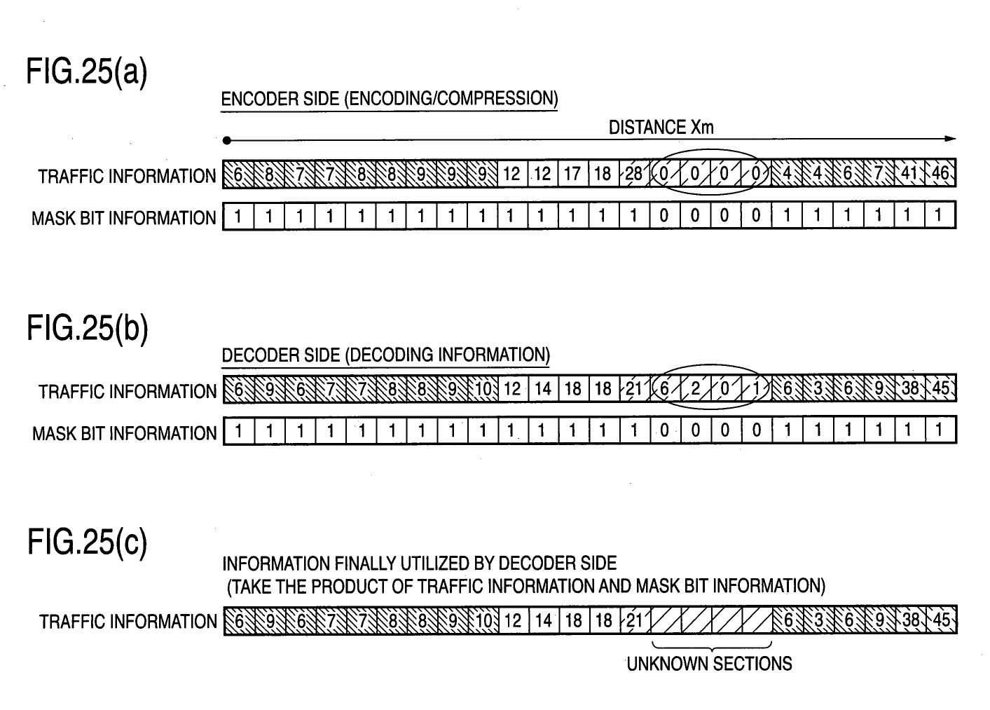

In case the mask bit information is provided together with the state volume of traffic information, when the traffic information is “unknown,” the receiving party can clearly identify the “unknown” section by using the mask bit information irrespective of the value set as the state value of traffic information. FIGS. 25A through 25C show the case where the state volume of the “unknown” section enclosed by an ellipse is set to 0 by the sending party. FIG. 25A schematically shows the traffic information and the mask bit information transmitted as encoded/compressed data from the sending party. FIG. 25B schematically shows the traffic information and the mask bit information received and decoded by the receiving party. The receiving party finally ANDs the traffic information and the mask bit information to reproduce the traffic information shown in FIG. 25C. In this case, even when the state volume of the “unknown” section in the decoded traffic information (FIG. 25B) has changed from 0 through variable-length encoding/compression, the state volume may be ANDed with the mask bit information in order to clarify the “unknown” section.

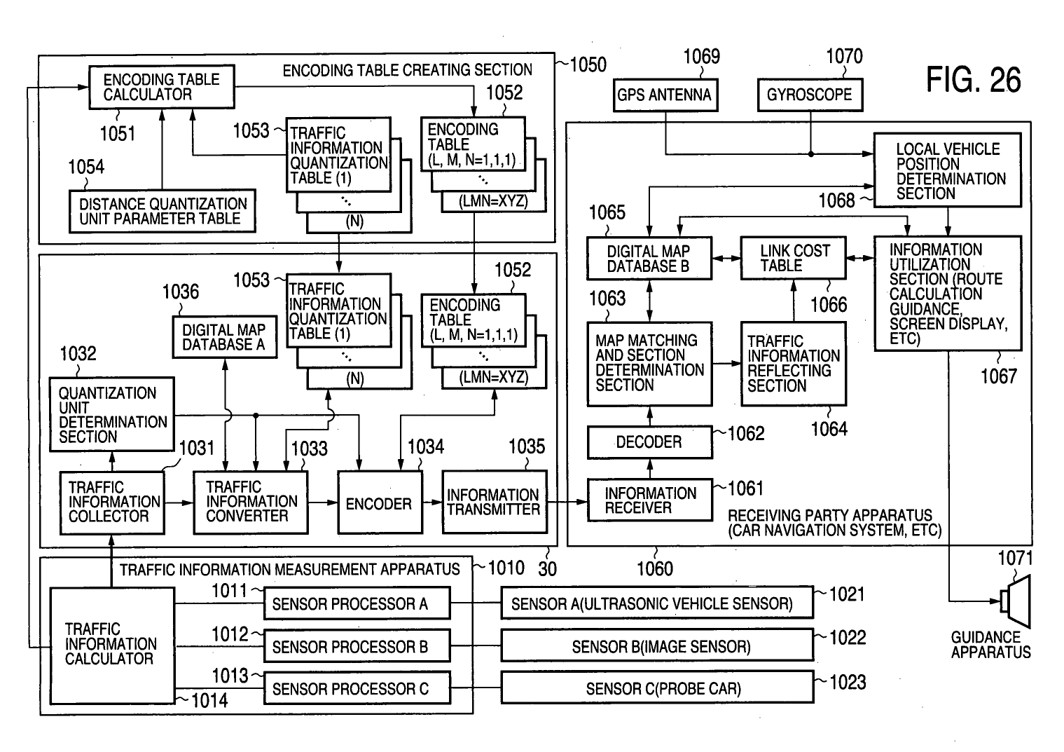

FIG. 26 shows a traffic information providing system which provides this traffic information. The system comprises: traffic information measurement apparatus 1010 for measuring traffic information by using a sensor A (ultrasonic vehicle sensor) 1021, a sensor B (AVI sensor) 1022 and a sensor C (probe car) 1023; an encoding table creating section 1050 for creating an encoding table to encode traffic information; a traffic information transmitter 1030 for encoding and transmitting the traffic information and the information on the target section; and receiving party apparatus 1060 such as car navigation apparatus for receiving the transmitted information.

The traffic information measurement apparatus 1010 comprises a sensor processor A1011, a sensor processor B1012 and a sensor processor C1013 for processing the data acquired from the sensors 1021, 1022, 1023; and traffic information calculator 1014 for generating traffic information by using the data processed by the sensor processors 1011, 1012, 1013 and outputting the traffic information and the target section data.

The encoding table creating section 1050 comprises plural types of traffic information quantization tables used for quantization of traffic information and a distance quantization unit parameter table 1054 for specifying plural types of sampling point intervals (unit block length). The encoding table calculator 1051 for creating an encoding table classifies past traffic acquired from the traffic information measurement apparatus 1010 and creates various types of encoding tables 1052 corresponding to all combinations of the traffic information quantization table 1053 and sampling point intervals for all patterns.

The traffic information transmitter 1030 comprises: a traffic information collector 1031 for collecting traffic information from the traffic information measurement apparatus 1010; a quantization unit determination section 1032 for determining the traffic situation based on the collected traffic information, determining the unit block length of the distance quantization unit, and determining the quantization table and encoding table to be used; traffic information converter 1033 for converting traffic information to a state volume at a sampling point (state volume of distance quantization unit) and generating mask bit information as well as converting the shape vector data in the target section to a statistical prediction difference value; an encoder 1034 for encoding traffic information by using the encoding table 1052 determined by the quantization unit determination section 1032 as well as encoding the shape vector in the target section; an information transmitter 1035 for transmitting the encoded traffic information data and shape vector data; and a digital map database referenced by the traffic information converter 1033.

In case the traffic state volume is presented by a difference from a statistical prediction value, the traffic information converter 1033 quantizes the traffic state volume or converts the traffic state volume to a statistical prediction difference value by using the distance quantization unit and the traffic information quantization table 1053 determined by the quantization unit determination section 1032 as well as generates mask bit information where 0 means that the traffic information is invalid and 1 means that the traffic information is valid. The encoder 1034 variable-length encodes the statistical prediction difference value of traffic information by using the encoding table 52 determined by the quantization unit determination section 1032 as well as encodes a mask bit string including 0s and 1s by way of the MH (modified Huffman) encoding system which is a standard encoding system for facsimiles. An example of MH encoding is described below.

In case traffic information is represented by a coefficient of frequency component, the traffic information converter 1033 converts the traffic state volume to a specific number of state volumes which will allow splitting into frequency components based on the distance quantization unit determined by the quantization unit determination section 1032 a well as generates the mask bit information for the traffic state volume. The encoder 1034 splits the traffic state volume into frequency components by using approaches such as FFT, DCT and DWT, quantizes its coefficient based on the quantization table determined by the quantization unit determination section 1032, variable-length encodes the quantized coefficient by using the encoding table determined by the quantization unit determination section 1032, and encodes the mask bit string by using the MH encoding system.

The receiving party apparatus 1060 comprises: an information receiver for receiving the information provided by the traffic information transmitter 1030; a decoder 1062 for decoding the received information to reproduce the traffic information and shape vector; a map matching and section determination section 1063 for performing map matching of a shape vector by using the data in the digital map database 1065 to determine the target section of traffic information; a traffic information reflecting section 1064 for reflecting the received traffic information into the data for the target section in the link cost table 1066; a local vehicle position determination section 1068 for determining the local vehicle position by using a GPS antenna 1069 and a gyroscope 1070; an information utilization section 1067 for utilizing the link cost table 1066 for route search from the local vehicle position to the destination; and guidance apparatus 1071 for performing voice guidance based on the route search result.

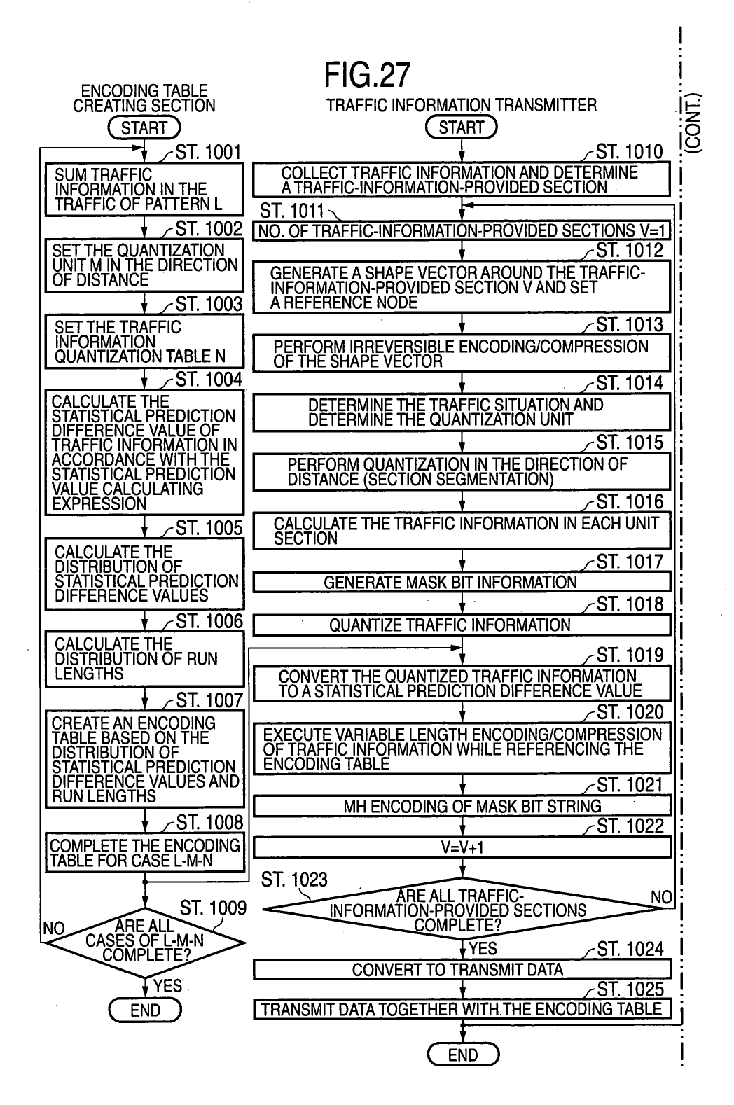

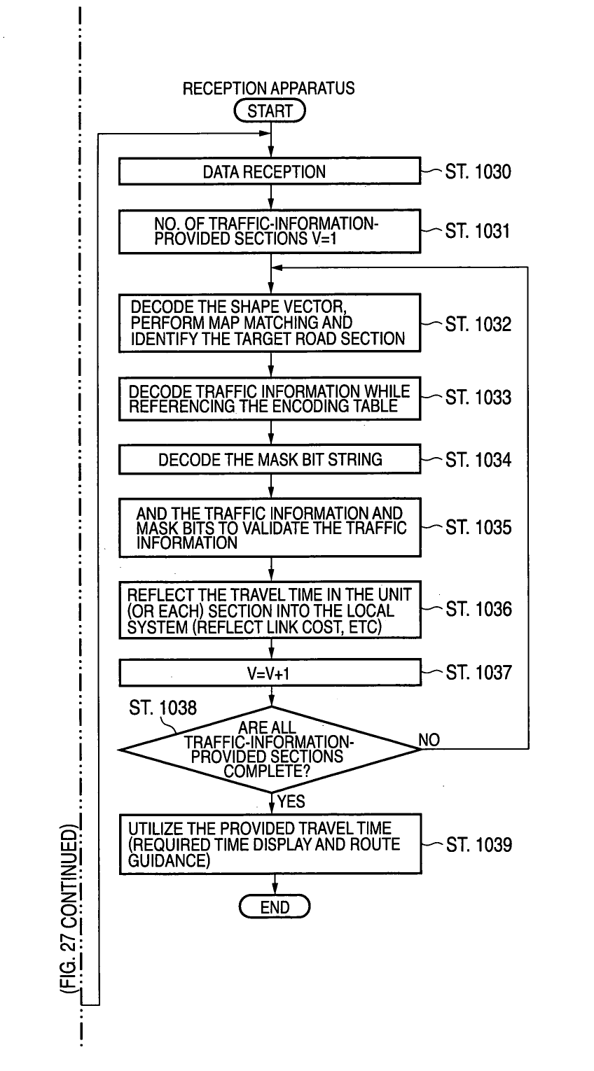

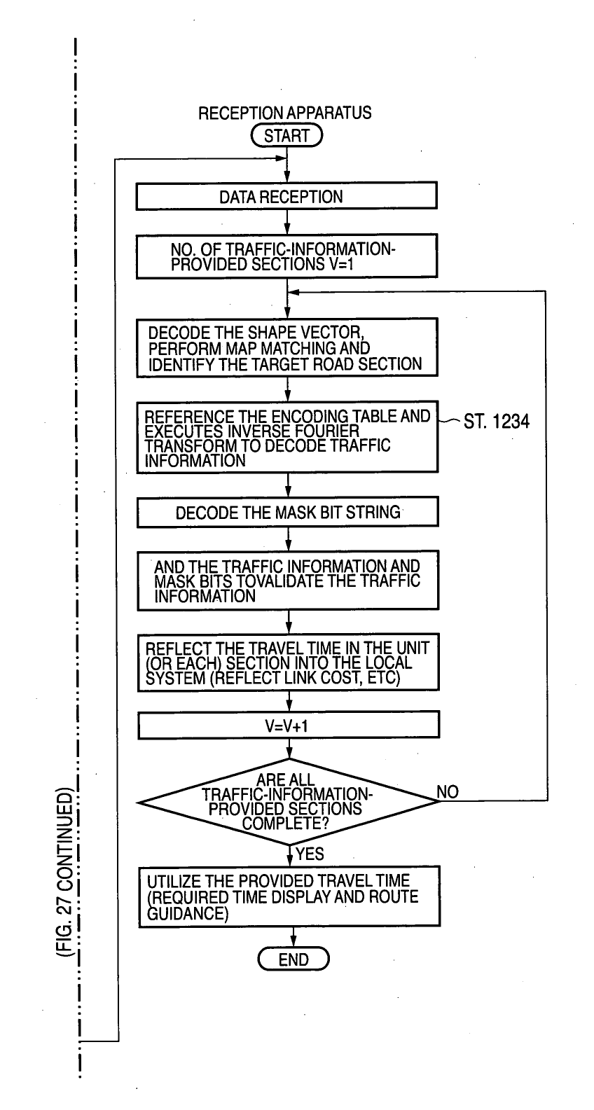

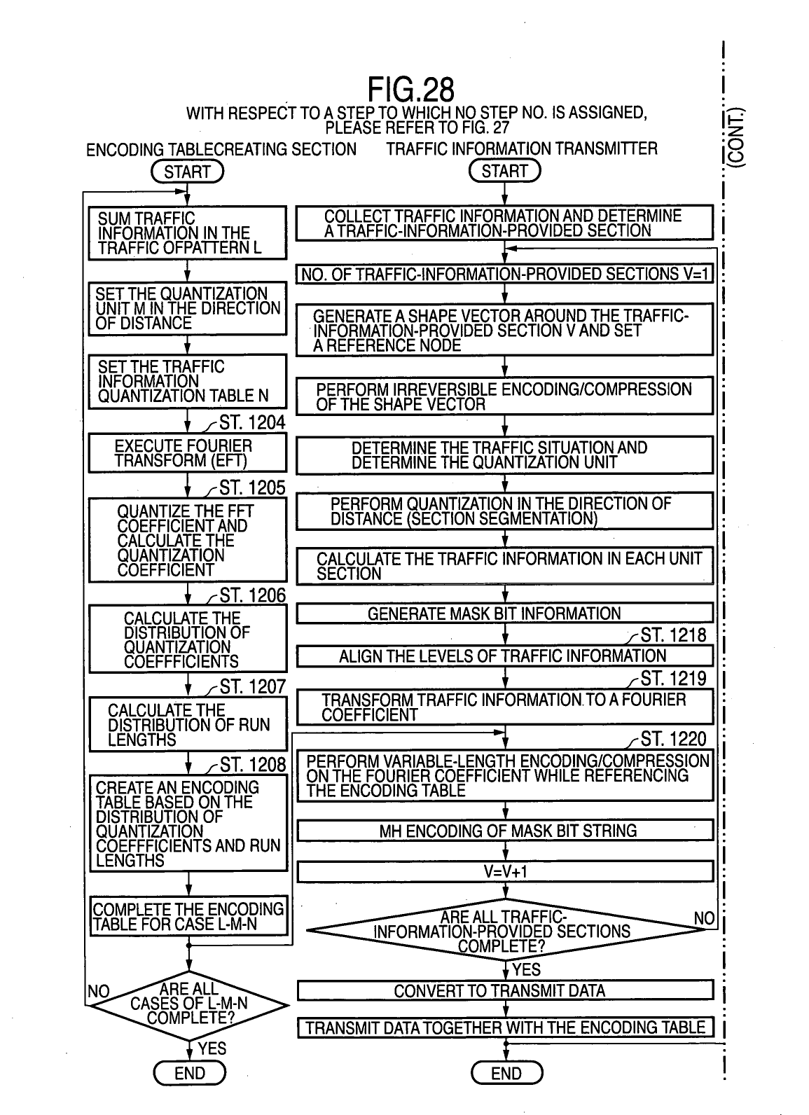

The flowchart of FIG. 27 shows the operation of each section assumed when the traffic state volume is represented by a difference from the statistical prediction value.

The encoding table calculator 1051 of the encoding table creating section 1050 analyzes the past traffic information transmitted from the traffic information measurement apparatus 1010 and sums traffic information in the traffic of pattern L (step 1001), sets the quantization unit in the direction of distance (distance quantization unit) M (step 1002), and sets the traffic information quantization table N (step 1003). Next, the encoding table calculator 1051 calculates the statistical prediction value S by using the statistical prediction value calculating expression, and calculates the difference between the traffic information state volume and S (statistical prediction difference value) (step 1004). Next, the encoding table calculator 1051 calculates the distribution of statistical prediction difference values (step 1005) and calculates the distribution of run lengths (continuous distribution of same value) (step 1006). The encoding table calculator 1051 creates an encoding table based on the distribution of statistical prediction difference values and run lengths (step 1007) to complete the encoding table for case L-M-N (step 1008). The encoding table calculator 1051 repeats the processing until all cases of L-M-N are complete (step 1009).

In this way, a large number of encoding tables supporting various traffic situation patterns and resolutions of information representation are previously created and maintained.

Next, the traffic information transmitter 1030 collects traffic information and determines a traffic-information-provided section (step 1010). Determining that one traffic-information-provided section V is to be addressed (step 1011), the traffic information transmitter 1030 generates a shape vector around the traffic-information-provided section V and sets a reference node (step 1012), then performs irreversible encoding/compression of the shape vector (step 1013). This irreversible encoding/compression method is detailed in Japanese Patent Application No. 2001-134318.

The quantization unit determination section 1032 determines the traffic situation and determines the sampling interval (unit block length of distance quantization unit) and the quantization level (step 1014). The traffic information converter 1033 performs sampling in the direction of distance from the reference node of the shape vector by using the determined unit block length and splits the traffic-information-provided section (step 1015), and calculates the state volume of traffic information of each quantization unit (step 1016). The traffic information converter 1033 sets mask bit information of 0 to a distance quantization unit whose state volume is invalid and sets mask bit information of 1 to a distance quantization unit whose state volume is valid (step 1017).

The traffic information converter 1033 performs quantization of traffic information by using the traffic information quantization table 1053 determined by the quantization unit determination section 1032 based on the quantization level (step 1018) and converts the quantized traffic information to a statistical prediction difference value (step 1019).

Next, the encoder 1034 executes variable length encoding/compression of quantized traffic information by using the encoding table 1052 determined by the quantization unit determination section 1032 (step 1020). The encoder 1034 encodes a mask bit information string including 0s and 1s of each distance quantization unit arranged in the direction of distance from the reference node of the shape vector (for example a mask bit string of 111111111111110000111111 for FIG. 25A) by using the MH encoding system (step 1021).

This processing is executed for all traffic-information-provided sections (step 1023). The information transmitter 1035 converts the encoded data to transmit data (step 1024) and transmits the data together with the encoding table (step 1025).

In the receiving party apparatus 1060, when the information receiver 1061 receives data (step 1030), for each traffic-information-provided section V (step 1031), the decoder 1062 decodes the shape vector and the map matching and section determination section 1063 performs map matching on its digital map database 1065 and identifies the target road section (step 1032). The decoder 1062 decodes the traffic information state volume of each distance quantization unit by referencing the encoding table (step 1033).

The decoder 1062 also decodes the mask bit string (step 1034) and validates the traffic information by ANDing the traffic information state volume of each distance quantization unit and the mask bit information.

The traffic information reflecting section 1064 reflects the decoded travel time in the link cost of the local system (step 1035). This processing is executed for all traffic-information-provided sections (steps 1036, 1037). The Information utilization section 1067 utilizes the provided travel time to execute required time display and route guidance (step 1038).

The flowchart of FIG. 28 shows the operation of each section assumed when the traffic state volume is represented by a coefficient of frequency component. The encoding table creating section 1050 executes FFT to obtain an FFT coefficient (step 1204), quantizes the FFT coefficient to calculate a quantization coefficient (step 1205), calculates the distribution of quantization coefficients (step 1207), calculates the distribution of run lengths (step 1207), and creates an encoding table based on them (step 1208).

The traffic information transmitter 1030 aligns the levels of traffic information set to a real part and an imaginary part (step 1218), executes FFT to transform the data to a Fourier coefficient (step 1219), and performs variable-length encoding/compression on the Fourier coefficient (step 1220).

The receiving party apparatus references the encoding table and executes inverse Fourier transform to decode traffic information (step 1234).

The remaining procedures are same as those in FIG. 27.

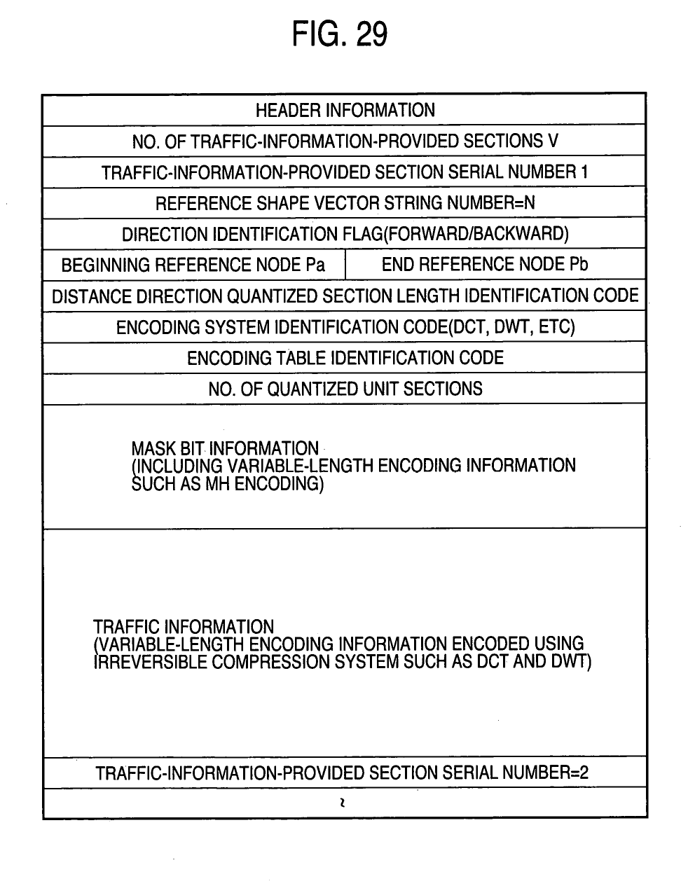

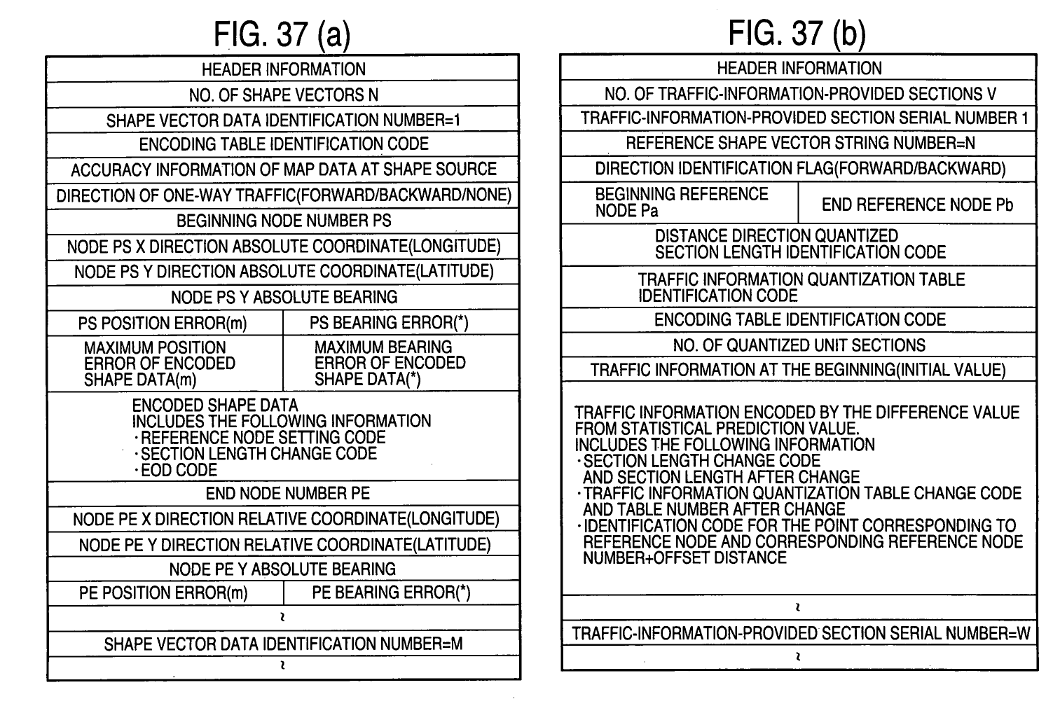

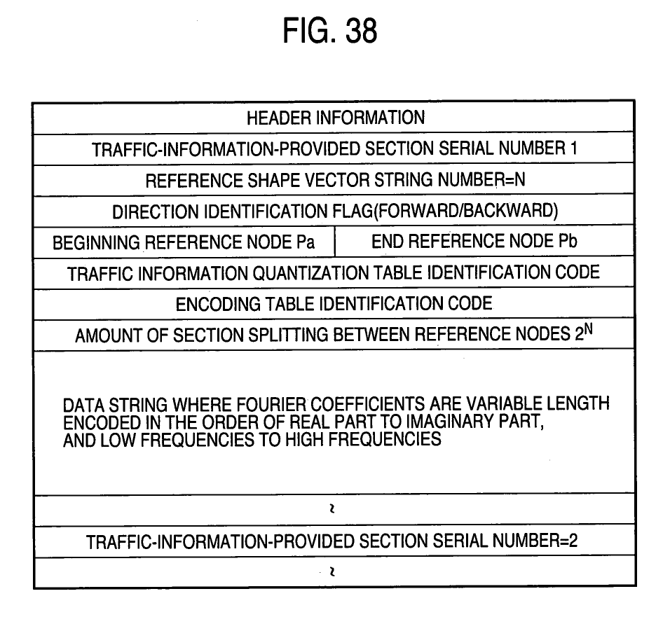

FIG. 29 shows an example of data structure of traffic information transmitted together with the shape vector data string information (FIG. 37A) from the traffic information transmitter 30. The data includes traffic information converted to the coefficient of frequency component by way of DCT and DWT and variable-length encoded and MH-encoded mask bit information.

In this way, the traffic information transmitter transmits the state volume of the distance quantization unit and mask bit information indicating that the state volume is valid or invalid. This allows the receiving party apparatus to clearly identify a section where the state volume is invalid (“unknown section”).

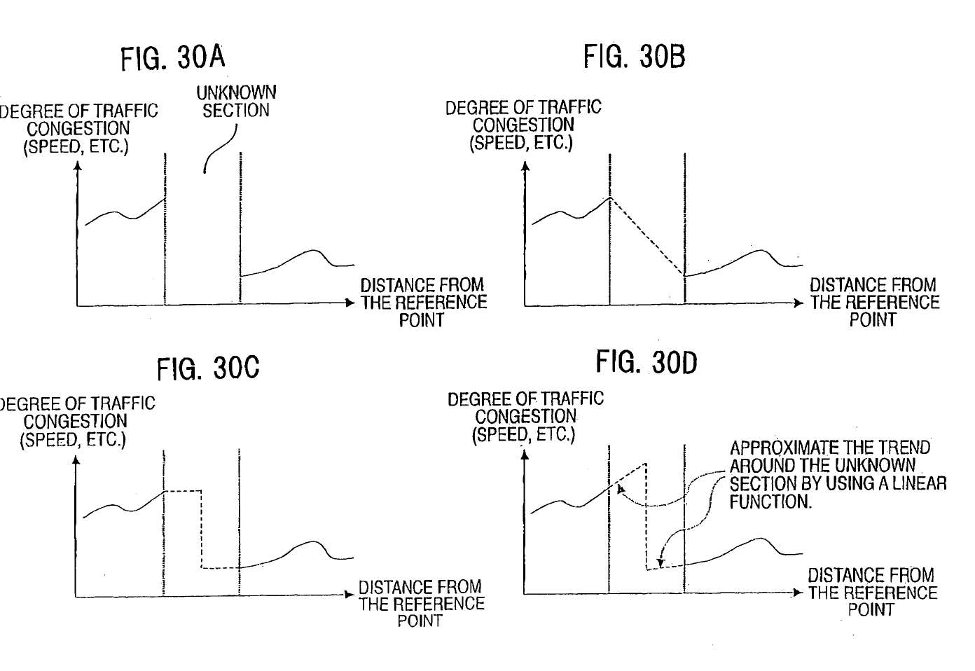

In this case, the receiving party can identify an “unknown” section irrespective of the state volume of the unknown section set by the sending party. This allows an arbitrary value of state volume of an “unknown” section to be specified. It is thus preferable to set a value, as a state volume of an “unknown section,” so that the state volume of a “valid” section before or after the “unknown” section will not be subject to alteration in the process of encoding and decoding. This is detailed referring to FIGS. 30A through 30D.

In FIGS. 30A through 30D, the horizontal axis shows a distance from the reference point of the target road section while the vertical axis shows a state volume-such as the speed at that distance. As shown in FIG. 30A, assume that an “unknown” section whose state volume is invalid exists in the target road section. In case the state volume of the “unknown” section is set to 0 as shown in FIGS. 25A through 25C, the state volume at the boundary of the “unknown” section is uniformized when frequency conversion/compression including irreversible encoding and orthogonal conversion is executed, so that the state volume of a “valid” section adjacent to An “unknown” section could significantly change from the original state volume when the state volume is reproduced at the receiving party (FIG. 25B).

In order to avoid such disadvantages, in FIG. 30B, values before and after an “unknown” section are connected with a straight line and the state volume of the “unknown” section is set to a value on this straight line. In FIG. 30C, state volumes before and after an “unknown” section is also maintained in the “unknown” section and the state volume is switched (both lines are connected) around the center of the “unknown” section. In FIG. 30D, the trend of state volumes before and after an “unknown” section is approximated with a function (a linear function in FIG. 30D but may be another function), and the state volume is switched near the center of the “unknown” section.

With this processing, an abrupt change in the state volume at a portion where an “unknown” section is adjacent to a “valid” section is avoided. The state volume in the “valid” section is free from the information in the “unknown” section, which allows correct reproduction of a state volume at the receiving party.

When a state volume is switched near the center of an “unknown” section is switched as in FIGS. 30C and 30D, the reproduced value of the state volume is disturbed when the state volume is reproduced. However, the center region is finally made unknown with a mask bit string, so that some shift in the state volume does not lead to a significant error.

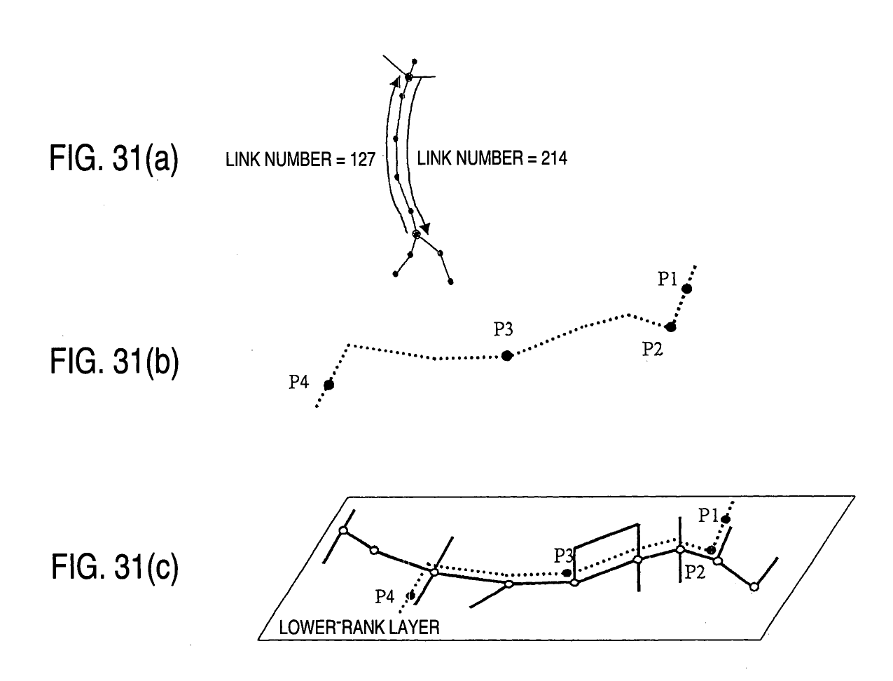

While a shape vector data string is transmitted to the receiving party in order to identify a target road section in the foregoing description, a road section identifier or intersection identifier may be used to identify a road section. For example, concerning two roads which reference the same map, as shown in FIG. 31A, a road section identifier or an intersection identifier may be used to identify a road and specify a reference section based on an absolute position. N sampling points are produced on the pertinent link and the traffic information is represented in traffic information at each sampling point.

Or, as shown in FIG. 31B, a target road may be identified by using the latitude/longitude data for position reference of the intermittent bodes P1, P1, P3, P4 extracted from a road in the middle of the link (which data holding the attribute information such as a name and a road type). In this example, P1 is a link midpoint, P2 is an intersection, P3 is a link midpoint, and P4 is a link midpoint. To identify a road section, as shown in FIG. 31C, the position of each of P1, P2, P3 and P4 is identified, and each section are interconnected through path search to identify the target road.

Road section reference data to identify a target road may be other than the aforementioned shape vector data string, road section identifier and intersection identifier. For example, an identifier assigned to each tile-shaped segment of a road map, a kilo post installed at a road, a road name, an address, and a ZIP code may be used as position reference information to identify a target road section of traffic information.

### NINTH EMBODIMENT

Concerning the ninth embodiment of the invention, a system is described below where a probe car to provide travel data functions as traffic information providing apparatus and a center to collect the information from the probe car functions as traffic information utilization apparatus. In this system, mask bit information is used to indicate that the measurement information from the probe car is valid or invalid.

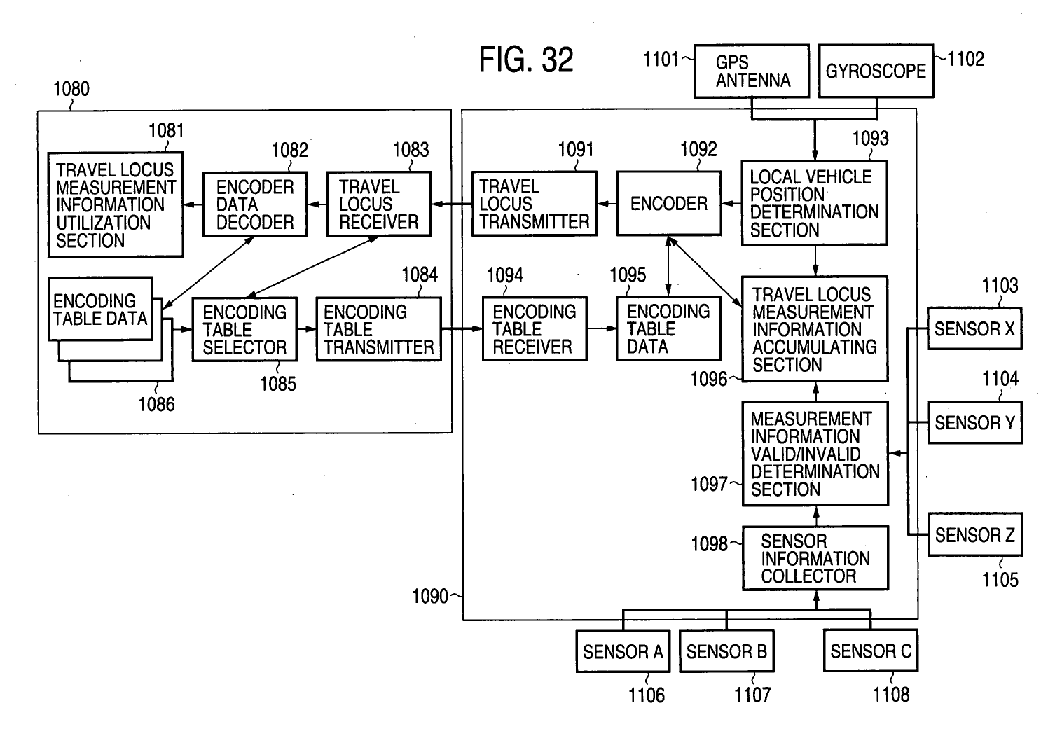

As shown in FIG. 32, the system comprises a probe-car-mounted machine 1090 for providing travel data and a probe car collection system 1080 for collecting data. The probe-car-mounted machine 1090 comprises: an encoding table receiver 1094 for receiving an encoding table used to encode transmit data from the probe car collection system 1080; a sensor information collector 1098 for collecting information detected by a sensor A 1106 for detecting a speed, a sensor B 1107 for detecting power output and a sensor C1108 for detecting fuel consumption; a sensor V1103 for outputting a door open signal and a sensor Y 1104 for outputting a hazard signal; a measurement information valid/invalid determination section 1097 for determining whether the data collected by a sensor information collector 1098 based on the signal of a sensor Z1105 for outputting a seta belt signal; a local vehicle position determination section 1093 for determining the local vehicle position by using the information received by a GPS antenna 1101 and information from a gyroscope 1102; a travel locus measurement information accumulating section 1096 for accumulating the travel locus of the local vehicle and the measurement information from the sensors A, B, C; an encoder 1092 for encoding the data accumulated in the travel locus measurement information accumulating section 1096 by using received encoding table data 1095; and a travel locus transmitter for transmitting the encoded data to a probe car collection system 1080.

The probe car collection system 1080 comprises: a travel locus receiver 1083 for receiving travel data from the Probe-car-mounted machine 1090; an encoded data decoder 1082 for decoding the received data by using the encoding table data 1086; a travel locus measurement information utilization section 1081 for utilizing the collected travel locus and measurement information; an encoding table selector 1085 for selecting an encoding table to be provided to the probe-car-mounted machine 1090 depending on the current position of the probe car; and an encoding table transmitter 1084 for transmitting the selected encoding table to the probe car.

The measurement information valid/invalid determination section 1097 of the probe-car-mounted machine 1090 determines whether the measurement values such as the speed information detected by the sensor A 1106, engine load detected by the sensor B 1107, and gasoline consumption detected by the sensor C 1108 are measurement values obtained while the probe car is traveling in a traffic flow, based on the signals transmitted from the sensors X, Y, Z, and stores into the Travel locus measurement information accumulating section 1096 the measurement information from the sensors A, B, C with a flag indicating the determination result attached.

For example, the measurement information valid/invalid determination section 1097 determines a normal travel, a stop or a short stop by way of hazard lamp on/off. The measurement information valid/invalid determination section 1097 detects that the vehicle is not traveling by checking the lamp illumination signal of a parking brake or P position signal of a car with an automatic transmission. The measurement information valid/invalid determination section 1097 detects a blinker signal and determines that the vehicle is getting past other vehicles in case it frequently turns on a blinker, for example at least twice within 45 seconds.

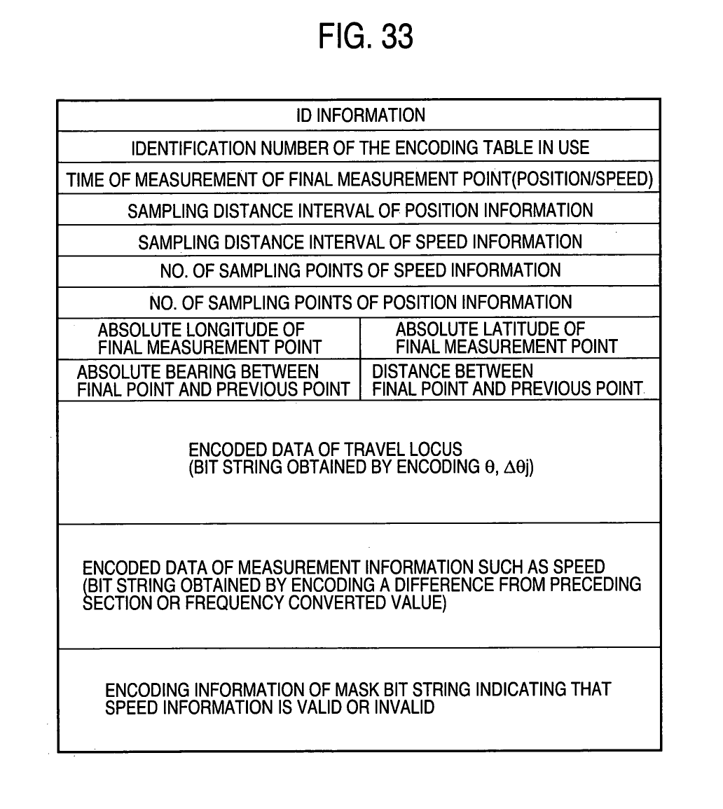

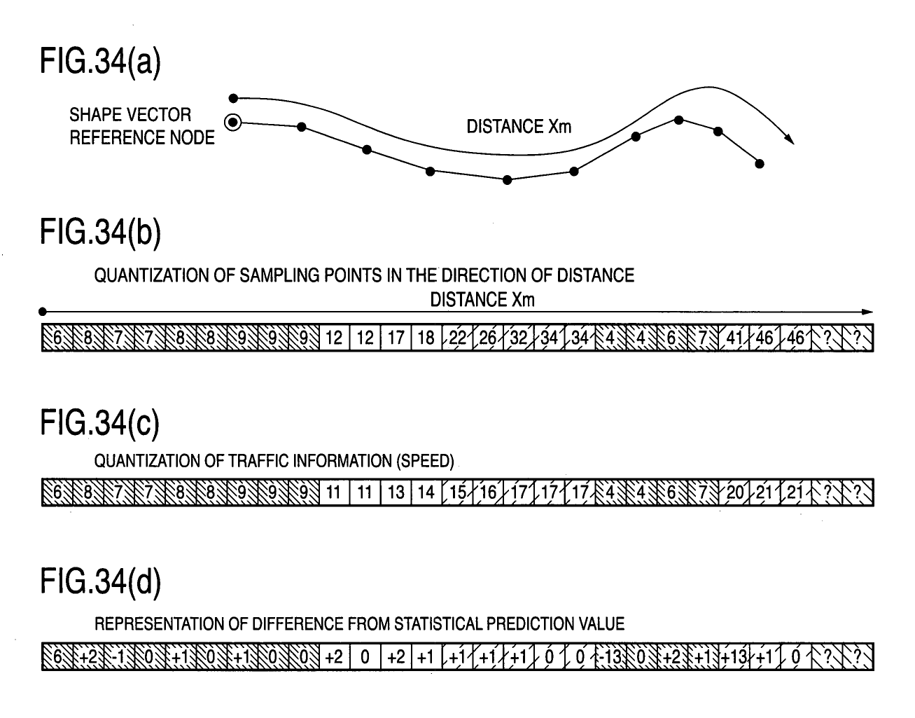

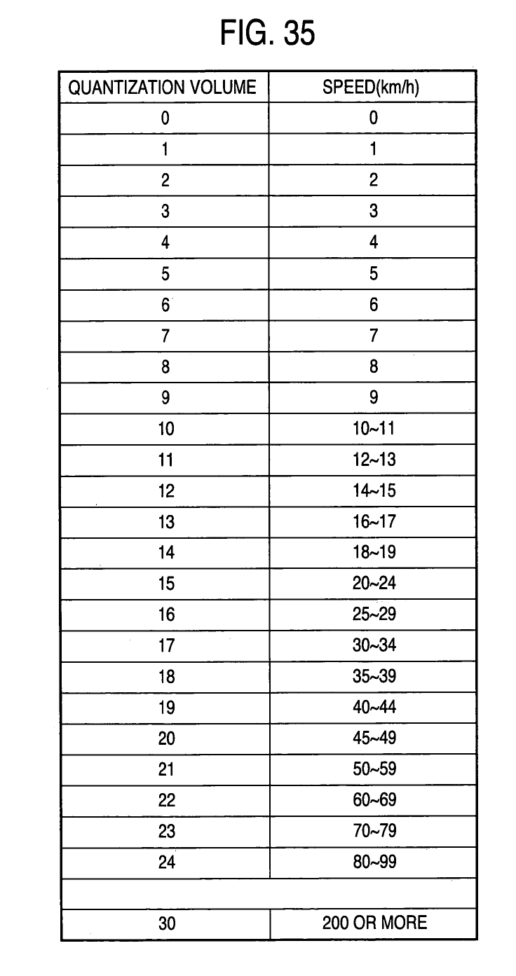

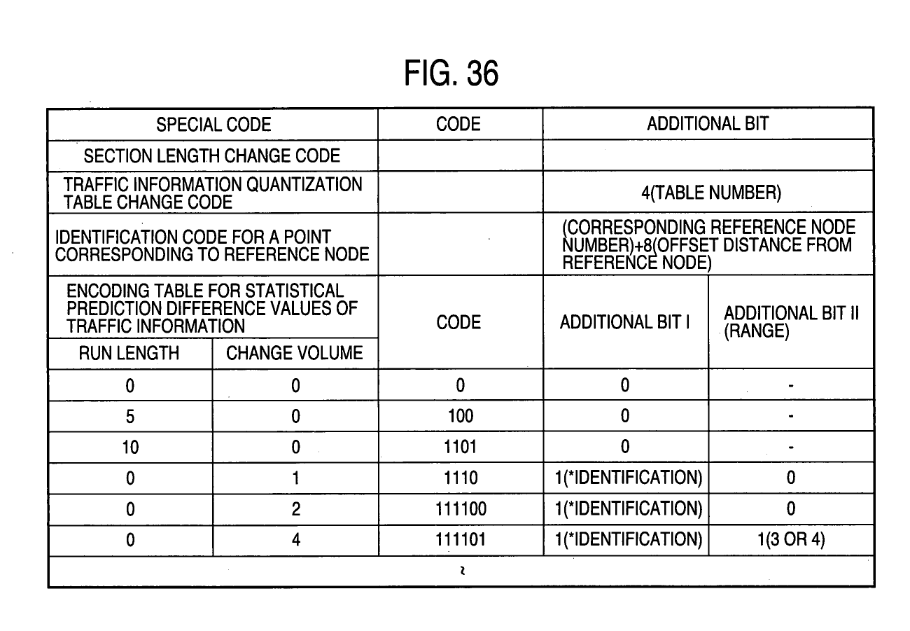

The encoder 1092 creates a mask bit string based on a flag attached by the measurement information valid/invalid determination section 1097 in encoding the travel locus data and measurement information accumulated in the travel locus measurement information accumulating section 1096. The travel locus data and measurement information to which this mask bit information attached is transmitted to the probe car collection system 1080. FIG. 33 illustrates a data structure of the data transmitted from the probe-car-mounted machine 1090 to the probe car collection system 1080.

The travel locus measurement information utilization section 1081 of the probe car collection system 1080 determines the validity of information collected by the probe-car-mounted machine 1090 based on the mask bit information attached thereto and determines the traffic volume by using the valid data.

In this way, it is possible to identify, by using mask bit information, the validity of information collected by a probe car.

While the invention has been detailed with reference to specific embodiments, those skilled in the art will appreciate that that various changes and modifications can be made in it without departing the spirit and scope thereof.

This patent application is based on Japanese Patent Application No. 2002-380403 filed Dec. 27, 2002, Japanese Patent Application No. 2002-380404 filed Dec. 27, 2002, and Japanese Patent Application No. 2003-414296 filed Dec. 12, 2003, the disclosure of which is incorporated herein by reference.

### INDUSTRIAL APPLICABILITY

The invention may be widely used in a center which provides traffic information and path information, a business entity which delivers the provided service, or car-mounted apparatus, a cell phone, a PDC and a PC which displays traffic information and path information.

The method of representing the road-related information according to the invention adds attribute information to traffic information and path information, which increases the volume and quality of information and enhances the utility value of information. In case information representing reliability is added to traffic information, the traffic information is properly evaluated. As a result, it is possible to properly set a link cost used for path search, thereby enhancing the accuracy of path search. It is also possible to properly set the information value of traffic information provided on a chargeable basis, which assures a reasonable charging system in a traffic information providing business.

In case the information on alienation of specific traffic information from normal traffic is added as attribute information, the user encountering an abrupt traffic situation whose transition is beyond prediction may take proper action based on the traffic information.

In case the information indicating the superiority of path information is added, as attribute information, to the path information provided to the user, the user may flexibly select a path, that is, select a presented path in a section with higher superiority and select a familiar, frequented road in a section with lower superiority.

The terminal apparatus according to the invention can display the traffic information and path information in a form easily understood by the user.

The path information calculator according to the invention can properly set a link cost by using gray scale information, thereby performing a highly accurate path search.

The traffic information providing system according to the invention uses gray scale information to employ a reasonable charging system where higher-accuracy traffic information costs the user higher while lower-accuracy traffic information costs the user lower.

The traffic information providing system according to the invention provides, as traffic information, the state volume of traffic information changing along a road as well as correctly communicates to the receiving party an “unknown” section whose state volume is not known.

The method of representing traffic information according to the invention correctly communicates an “unknown” section as well as state volume of traffic information in a valid section adjacent to the “unknown” section.

1. A method of representing road-related information characterized by representing road-related information together with gray scale information for displaying attributes of said road-related information in multiple levels.

2. The method of representing road-related information according to claim 1, characterized in that said road-related information is traffic information and the traffic information is represented by a state volume of traffic information and gray scale information for displaying the attributes of said state volume in multiple levels.

3. The method of representing road-related information according to claim 2, characterized by displaying reliability of the state volume of said traffic information in multiple levels by using said gray scale information.

4. The method of representing road-related information according to claim 3, characterized by representing the state volume of said traffic information by state volume at each of sampling points set by segmenting a target road and representing the reliability of said state volume by a numeric value of said gray scale information associated with each of said sampling points.

5. The method of representing road-related information according to claim 3, characterized by displaying a line according to the state volume of said traffic information on a map and changing transmittance of said line depending on the reliability represented by said gray scale information.

6. The method of representing road-related information according to claim 3, characterized by displaying a line according to the state volume of said traffic information on a map and changing a thickness of said line depending on the reliability represented by said gray scale information.

7. The method of representing road-related information according to claim 3, characterized by displaying a line according to the state volume of said traffic information on a map and changing a line type of said line depending on the reliability represented by said gray scale information.

8. The method of representing road-related information according to claim 3, characterized by setting the reliability represented by said gray scale information by using installation density of sensors which collect the state volume of said traffic information.

9. The method of representing road-related information according to claim 3, characterized by setting the reliability represented by said gray scale information by using detection accuracy of sensors which collect the state volume of said traffic information.

10. The method of representing road-related information according to claim 3, characterized by setting the reliability represented by said gray scale information by using a time which has elapsed since the state volume of said traffic information was collected.

11. The method of representing road-related information according to claim 3, characterized by setting the reliability represented by said gray scale information by using the chronological variations in the state volume of said traffic information.

12. The method of representing road-related information according to claim 3, characterized by setting the reliability represented by said gray scale information by using variations in the state volume of said traffic information in a predetermined period.

13. The method of representing road-related information according to claim 3, characterized by setting the reliability represented by said gray scale information by using a difference between the state volume of said traffic information obtained based on information from a sensor installed at a road and said state volume obtained based on information from a probe car.

14. The method of representing road-related information according to claim 3, characterized by setting the reliability represented by said gray scale information by way of accuracy of a calculation system used to estimate the state volume of said traffic information.

15. The method of representing road-related information according to claim 3, characterized by setting the reliability represented by said gray scale information by way of variations in an estimation result of the state volume of said traffic information.

16. The method of representing road-related information according to claim 3, characterized by setting the reliability represented by said gray scale information by way of a percentage of correct answers in the estimation record of the state volume of said traffic information.

17. The method of representing road-related information according to claim 3, characterized by setting the reliability represented by said gray scale information by way of number of samples of probe car information used to determine the state volume of said traffic information.

18. The method of representing road-related information according to claim 2, characterized by displaying a difference of the state volume of said traffic information from normal traffic in multiple levels by using said gray scale information.

19. The method of representing road-related information according to claim 18, characterized by obtaining said difference by comparing the state volume of newly measured traffic information with a statistical value ofthe state volume of said traffic information measured in plural occasions in the past.

20. The method of representing road-related information according to claim 19, characterized by using the state volume of past traffic information in which a day type of a measurement day is common, as a reference used for comparison of the state volume of said newly measured traffic information.

21. The method of representing road-related information according to claim 19, characterized by using the state volume of past traffic information in which weather of a measurement day is the same, as a reference used for comparison of the state volume of said newly measured traffic information.

22. The method of representing road-related information according to claim 2, characterized by displaying variations in the state volume of said traffic information in multiple levels.

23. The method of representing road-related information according to claim 1, characterized in that said road-related information is path information and said path information is represented by said path information and the gray scale information for displaying the attributes of said path information in multiple levels.

24. The method of representing road-related information according to claim 23, characterized by displaying the superiority of a shortest-travel-time path over the other paths by way of said gray scale information.

25. The method of representing road-related information according to claim 24, characterized by using a shortest-distance path as a reference path of said superiority.

26. The method of representing road-related information according to claim 24, characterized by using a pre-registered path as a reference path of said superiority.

27. The method of representing road-related information according to claim 24, characterized by segmenting said shortest-travel-time path into a plurality of sections and respectively obtaining the superiority ofthe shortest-travel-time path in each section over a reference path set in each section.

28. The method of representing road-related information according to claim 24, characterized by setting a reference path between a beginning and an end of said shortest-travel-time path to set, to maximum, said superiority of a section where said shortest-travel-time path and the reference path match each other, thereby obtaining the superiority of a section where said shortest-travel-time path and the reference path differ from each other.

29. Terminal apparatus comprising: reception means for receiving gray scale information which displays a state volume of traffic information and attributes of said state volume in multiple levels; and display means for displaying the state volume of said traffic information in a form corresponding to the value of said gray scale information.

30. The terminal apparatus according to claim 29, characterized by comprising transmission means for transmitting information which indicates a reference of said state volume to a center which provides said traffic information and gray scale information.

31. Terminal apparatus characterized by comprising:
transmission means for transmitting information on a current position and a destination;
reception means for receiving gray scale information for displaying path information and superiority of said path information in multiple levels; and display means for displaying said path information in a form corresponding to the value of said gray scale information.

32. Terminal apparatus characterized by comprising: reception means for receiving traffic information; route calculation means for calculating a shortest-travel-time path from a current position to a destination by referencing said traffic information; attribute information calculation means for displaying superiority of said shortest-travel-time path in multiple levels; and display means for displaying said shortest-travel-time path in a form corresponding to the value of said gray scale information.

33. Path information calculation apparatus comprising: dynamic link cost calculation means for calculating a dynamic link cost of a link based on a state volume of traffic information;
static link cost provision means for providing a static link cost of said link; and link cost determination means for changing a distribution ratio of the dynamic link cost and static link cost based on a gray scale information which represents reliability of superiority of traffic information in multiple levels in order to generate a link cost used for path calculation.

34. A traffic information providing system comprising: traffic information providing apparatus for retaining, as traffic information, a state volume of traffic information and gray scale information for displaying the reliability of said state volume in multiple levels and providing traffic information to which said gray scale information is appended; and client apparatus for receiving said traffic information from said traffic information providing apparatus; characterized in that said traffic information providing apparatus sets a value of traffic information to be provided to said client apparatus in accordance with said gray scale information appended to said traffic information.

35. A traffic information providing system comprising: traffic information providing apparatus for providing, as traffic information, a state volume of traffic information at each of the sampling points set by segmenting a target road and mask bit information indicating that said state volume is valid or invalid; and traffic information utilization apparatus for receiving said traffic information and reproducing said valid state volume by using said mask bit information.

36. The traffic information providing system according to claim 35, characterized in that said traffic information providing apparatus provides information which represents, as said mask bit information, said valid state volume by 1 and said invalid state volume by 0 and that said traffic information utilization apparatus obtains a logical product of said state volume provided by said traffic information providing apparatus and said mask bit information corresponding to the state volume and reproduces a valid state volume.

37. The traffic information providing system according to claim 35, characterized in that said traffic information providing apparatus provides, as said traffic information, data representing an array of said state volumes and data representing an array of said mask bit information.

38. The traffic information providing system according to claim 37, characterized in that said traffic information providing apparatus quantizes the data representing an array of said state volumes, converts the obtained value into a value statistically deviated, variable-length encodes the obtained value and provides the encoded value, and encodes the data representing the array of said mask bit information and provides the encoded data.

39. The traffic information providing system according to claim 37, characterized in that said traffic information providing apparatus converts the data representing the array of said state volumes to a coefficient of frequency component, quantizes said coefficient, variable-length encodes the obtained value and provides the encoded value, and encodes the data representing an array of said mask bit information and provides the encoded data.

40. The traffic information providing system according to claim 35, characterized in that said traffic information providing apparatus sets said state volume at a sampling point where said state volume is invalid to a value approximate to a valid state volume of an adjacent sampling point.

41. The traffic information providing system according to claim 40, characterized in that, when said state volumes of a plurality of sampling points constituting continuous sections are all invalid, said traffic information providing apparatus sets the state volume at each of said plurality of sampling points to a value which continuously changes from a valid state volume at a sampling point adjacent to the beginning of said continuous sections to a valid state volume at a sampling point adjacent to the end of said continuous sections.

42. The traffic information providing system according to claim 40, characterized in that, when said state volumes of a plurality of sampling points constituting continuous sections are all invalid, said traffic information providing apparatus sets the state volume of a sampling point from the beginning to the center of said continuous sections to a same value as a valid state volume at a sampling point adjacent to the beginning of said continuous sections and sets the state volume of a sampling point from the center to the end of said continuous sections to a same value as a valid state volume at a sampling point adjacent to the end of said continuous sections.

43. The traffic information providing system according to claim 40, characterized in that, when said state volumes of a plurality of sampling points constituting continuous sections are all invalid, said traffic information providing apparatus sets the state volume of a sampling point from the beginning to the center of said continuous sections to a value obtained through functional approximation using valid state volume of a plurality of sampling points beyond the beginning of said continuous sections and sets the state volume of a sampling point from the center to the end of said continuous sections to a value obtained through functional approximation using valid state volume of a plurality of sampling points beyond the end of said continuous sections.

44. The traffic information providing system according to claim 35, characterized in that said traffic information providing apparatus provides said traffic information as well as road section reference data to identify said target road and that said traffic information utilization apparatus identifies said target road from said road section reference data.

45. Traffic information providing system used in the traffic information providing system according to claim 35, characterized by comprising: a traffic information converter for converting a state volume of traffic information changing along a road to an array of values of sampling points set by segmenting a target road as well as generating an array of mask bit information indicating that said values are valid or invalid; an encoder for encoding data generated by said traffic information converted from said state volume of traffic information and data of said mask bit information; and an information transmitter for transmitting the data encoded by said encoder.

46. Traffic information utilization system used in the traffic information providing system according to claim 35, characterized by comprising: an information receiver for receiving, from traffic information providing apparatus, encoded data concerning the state volume of traffic information on a target road, encoded data of mask bit information indicating that said state volume values are valid or invalid, and road section reference data to identify said target road; a decoder for decoding each item of said encoded data and reproducing a valid state volume from said state volume of traffic information and said mask bit information; and a determination section for performing map matching by using said road section reference data and identifying the target road of said traffic information.

47. A traffic information display method characterized by segmenting a target road of traffic information to set sampling points, setting 1 of mask bit information in association with said sampling point where a valid state volume of traffic information is obtained, setting 0 of mask bit information in association with said sampling point where a valid state volume of traffic information is not obtained, and presenting an array of said mask bit information together with an array of state volumes of said sampling points.
